(19) United States
(12) Patent Application Publication
(10) Pub. No.: US 2024/0166792 A1
(43) Pub. Date: May 23, 2024

(54) THERMOPLASTIC GRAFT ELASTOMERS VIA REACTIVE COMPATIBILIZATION OF POLYACRYLATED EPOXIDIZED HIGH OLEIC SOYBEAN OIL AND POLYDIENE-CONTAINING COPOLYMERS

(71) Applicant: IOWA STATE UNIVERSITY RESEARCH FOUNDATION, INC., Ames, IA (US)

(72) Inventors: Eric W. COCHRAN, Ames, IA (US); R. Chris WILLIAMS, Ames, IA (US); Nacu HERNANDEZ, Ames, IA (US); Austin HOHMANN, Dubuque, IA (US); Baker W. KUEHL, Ankeny, IA (US); Michael J. FORRESTER, Boone, IA (US)

(21) Appl. No.: 18/553,607

(22) PCT Filed: Apr. 1, 2022
(86) PCT No.: PCT/US2022/023102

§ 371 Date: Oct. 2, 2023

Related U.S. Application Data
(60) Provisional application No. 63/170,187, filed on Apr. 2, 2021.

(51) Int. Cl. C08F 283/00; B60C 1/00; C08F 293/00; C08L 95/00; C09J 151/08

(52) U.S. Cl. CPC C08F 283/00; B60C 1/00; C08F 293/005; C08L 95/00; C09J 151/08; C08F 2438/03

(57) ABSTRACT

The present application relates to a thermoplastic graft copolymer including one or more thermoplastic polymers of formula (I): and a branched chain thermoplastic polymer of formula (II): where R¹, R^{1′}, R², R^{2′}, R³, R⁴, R^{4′}, AETAG, a, b, c, e, f, g, h, i, and j are as described herein. Also disclosed is the process for preparing the thermoplastic copolymer and its uses.

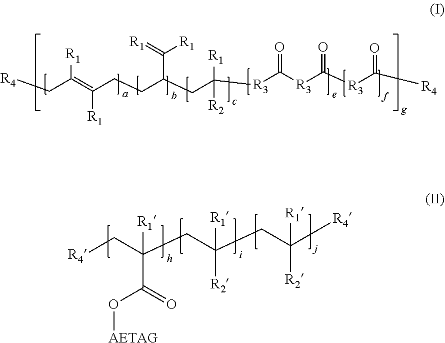

This application claims the priority benefit of U.S. Provisional Patent Application Ser. No. 63/170,187, filed Apr. 2, 2021, which is hereby incorporated by reference in its entirety.

### FIELD

The present application relates to thermoplastic graft copolymers including acrylated epoxidized vegetable oils.

### BACKGROUND

In the thermoplastic and thermoplastic elastomer industry, various styrenic and diene-based polymers have been used for nearly endless applications. Polymers such as acrylonitrile-butadiene-styrene terpolymer (ABS) and styrene-b-butadiene-b-styrene (SBS) block copolymer are widely used for their mechanical performance and ability to be extruded. While these polymers display excellent processability and mechanical performance, the volatile price of butadiene, along with its non-renewable nature, has caused an extensive amount of time and resources to be dedicated to reducing the dependence on non-renewable feedstocks. Alternative sources for polymers or their feedstocks, such as renewable natural resources, could provide a sustainable source for the plastic industry. Renewable resources can vary from materials derived from trees and plants to synthetically altered sugars, fats, oils, and proteins. Polymers derived from these various biological sources can produce various materials that have properties ranging from elastomeric to rigid. Biopolymers possess the potential to be more environmentally friendly and more economically stable than their petroleum counterparts. Biopolymers need to assimilate the properties of petroleum-based polymers using an abundant, low-cost commodity feedstock that enables an economical pathway to commercialize a high value or volume application.

Concerns over green-house gas emissions caused by nondegradable, petroleum-derived engineering thermoplastics has recently caused a drive for more sustainable alternatives (Hottle et al., Waste Management 38:86-94 (2015); A. J. J. Straathof, Chem. Rev. 114:1871-1908 (2014)). Polylactide (PLA) has recently been shown to be a successful example of a bio-derived degradable polyester, by both commercial volume and overall production cost (Zhang et al., ACS Appl. Mater. Interfaces 6:12436-12448 (2014)). Although PLA contains a high tensile strength and elastic modulus, pristine PLA is brittle and prevents further developments in applications requiring ductility and impact resistance (Xu et al., Macromolecules 50:6421-6432 (2017)). Since PLA shares many limitations with other commodity thermoplastics, similar strategies have been used to alter the mechanical properties of various petroleum based thermoplastics such as polystyrene (PS) and poly butylene terephalate (PBT). Many of these techniques include copolymerization (Grijpma and Pennings, Macromol. Chem. Phys. 195:1649-1663 (1994); Hiljanen-Vainio et al., J. Appl. Polym. Sci. 59:1281-1288 (1996)), plasticization (Liu et al., Polymer 148:109-118 (2018); Mauck et al., Macromolecules 49:1605-1615 (2016)), extrusion with flexible polymers (Wang et al., Polym. Eng. Sci. 49:26-33 (2009); Meng et al., Mater. Des. 139:188-197 (2018)), and dynamic vulcanization (Zhao et al., ACS Sustain. Chem. Eng. 5:1938-1947 (2017); Liu et al., Macromolecules 43:6058-6066 (2010)).

Copolymers of lactide with other cyclic monomers, such as poly caprolactone (PCL), can be used to generate statistical or block copolymers with exact mechanical property profiles; however, many of these copolymers are prohibitively expensive for use as single use plastics, and are solely used in low volume high value applications (Jing and Hillmyer, J. Am. Chem. Soc. 130:13826-13827 (2008); Theryo et al., Macromolecules 43:7394-7397 (2010)). Dynamic vulcanization has proven to be an effective way to enhance the toughness of PLA but crosslinking can cause issues with reprocessing the material as the matrix transitions from a thermoplastic to a thermoset (He et al., RSC Adv. 4:12857-12866 (2014)). Designing a low cost high volume toughened PLA thermoplastic resides in synthesizing polymer blends. This is similar to how Acrylonitrile-co-Styrene (SAN) matrix is toughened with butadiene micelles to synthesize acrylonitrile-butadiene-styrene (ABS). A limitation of polymer-polymer blends is the immiscibility caused by the interfacial energy between the matrix and dispersed phases (Gramlich et al., Macromolecules 43:2313-2321 (2010); Xue et al., Polymers 10:1401 (2018)). Compatibilizers are used to stabilize the interface to form stable blends. Reactive extrusion has been used to generate graft copolymers between the matrix and the dispersed polymer and has been shown to provide a highly toughened PLA at loadings<20% (Wang et al., Polymer 92:74-83 (2016); Wang et al., Eur. Polym. J. 85:92-104 (2016); Liu et al., Macromolecules 43:6058-6066 (2010)). Block copolymers have also been used as a compatibilizer with PLA where one block is matrix miscible and another is matrix immiscible (Li et al., ACS Macro Letters 5:359-364 (2016); Liu et al., Macromolecules 43:7238-7243 (2010)). These block copolymers can be dispersed throughout the thermoplastic matrix at the nano scale and can significantly toughen PLA with loadings (>5%). While both of these strategies can toughen PLA at small loadings, these impact modifiers are still petroleum based.

Additionally, the demand for lighter distillate fractions such as gasoline, diesel, jet fuel, etc. has caused an effect in the asphalt market. Asphalt binders are increasing in stiffness requiring the need to restore the asphalt to its “virgin-like” state. Asphalt modification is typically done with SBS polymers through high shear and elevated temperatures to provide a well-dispersed elastomeric network. SBS incorporation typically is performed at asphalt terminals who possess the capability of producing polymer modified asphalt cement (PMAC). The asphalt industry has displayed interest in a SBS-like pellet that can bypass the typical high shear and elevated temperatures requirement.

The present application is directed to overcoming these and other limitations in the art.

### SUMMARY

The present application relates to thermoplastic graft copolymer including:
one or more thermoplastic polymers of formula I:

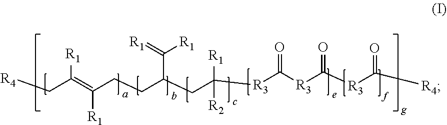

and
a branched chain thermoplastic polymer of formula II:

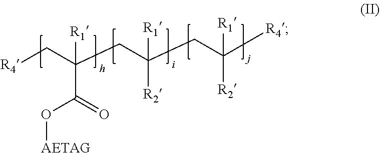

where
R¹ and R¹′ are independently selected at each occurrence thereof from the group consisting of H and methyl;
R² and R²′ are independently selected at each occurrence thereof from the group consisting of H, OH, halogen, —COOR⁵, —C(O)NR⁵R⁶, C₁-C₂₃ alkyl, and benzyl, where the C₁-C₂₃ alkyl can be optionally substituted with an aryl, heteroaryl, or heterocyclyl;
R³ is independently selected at each occurrence thereof from the group consisting of —X—R⁷—X—, C₁-C₂₃ alkylene, arylene, and heteroarylene;
R⁴ and R⁴′ are independently selected at each occurrence thereof from the group consisting of C₁-C₂₃ alkyl and benzyl, where the C₁-C₂₃ alkyl can be optionally substituted with an aryl, heteroaryl, heterocyclyl, carboxylic acid, oxirane, ester, thioester, or carbonotrithioate;
R⁵ and R⁶ are independently selected at each occurrence thereof from the group consisting of H and C₁₋₁₀ alkyl, hydoxyalkyl, or alkyloxirane;
R⁷ is independently selected at each occurrence thereof from the group consisting of

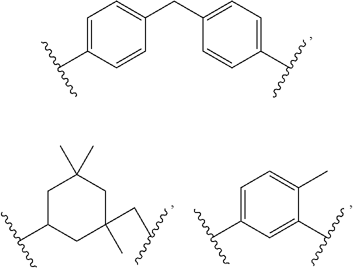

C₁₋₂₃ alkyl, where the C₁-C₂₃ alkyl can be optionally substituted with an aryl, heteroaryl, or heterocyclyl;
X is independently selected at each occurrence thereof from the group consisting of methylene, —NH—, or —O—.
AETAG is a (meth)acrylated epoxidized triacyl glyceride;
a, b, c, d, e, and f represent number average degrees of polymerization for repeat units of formula I that are distributed throughout the polymer chain in a statistically defined manner;
a, b, c, d, e, and f range from 0 to 100,000, where a+b+c+d+e+f ranges from 100 to 200,000;
g ranges from 1 to 5;
h, i, and j represent number average degrees of polymerization for repeat units of formula II that are distributed throughout the polymer chain in a statistically defined manner;
h ranges from 100 to 100,000; and
i and j range from 0 to 100,000, where the thermoplastic polymer of formula I is grafted to the thermoplastic polymer of formula II.

A second aspect of the present application relates to thermoplastic polymeric mixture including:
one or more thermoplastic polymers of formula I:

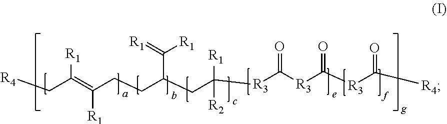

a branched chain thermoplastic polymer of formula II:

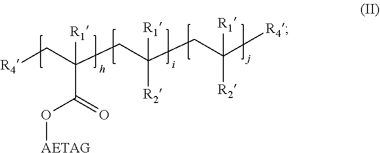

and
the graft copolymer of the present application;
   where
R¹ and R¹′ are independently selected at each occurrence thereof from the group consisting of H and methyl;
R² and R²′ are independently selected at each occurrence thereof from the group consisting of H, OH, halogen, —COOR⁵, —C(O)NR⁵R⁶, C₁-C₂₃ alkyl, and benzyl, where the C₁-C₂₃ alkyl can be optionally substituted with an aryl, heteroaryl, or heterocyclyl;
R³ is independently selected at each occurrence thereof from the group consisting of —X—R⁷—X—, C₁-C₂₃ alkylene, arylene, and heteroarylene;
R⁴ and R⁴′ are independently selected at each occurrence thereof from the group consisting of C₁-C₂₃ alkyl and benzyl, where the C₁-C₂₃ alkyl can be optionally substituted with an aryl, heteroaryl, heterocyclyl, carboxylic acid, oxirane, ester, thioester, or carbonotrithioate;
R⁵ and R⁶ are independently selected at each occurrence thereof from the group consisting of H and C₁₋₁₀ alkyl, hydoxyalkyl, or alkyloxirane;
R⁷ is independently selected at each occurrence thereof from the group consisting of

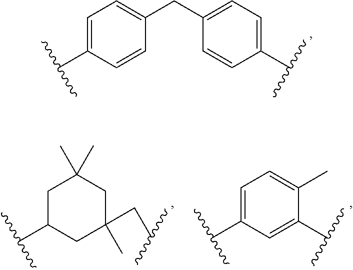

C₁₋₂₃ alkyl, where the C₁-C₂₃ alkyl can be optionally substituted with an aryl, heteroaryl, or heterocyclyl;
X is independently selected at each occurrence thereof from the group consisting of methylene, —NH—, or —O—.
AETAG is a (meth)acrylated epoxidized triacyl glyceride;
a, b, c, d, e, and f represent number average degrees of polymerization for repeat units of formula I that are distributed throughout the polymer chain in a statistically defined manner;
a, b, c, d, e, and f range from 0 to 100,000, where a+b+c+d+e+f ranges from 100 to 200,000;
g ranges from 1 to 5;
h, i, and j represent number average degrees of polymerization for repeat units of formula II that are distributed throughout the polymer chain in a statistically defined manner;
h ranges from 100 to 100,000; and
i and j range from 0 to 100,000, where the thermoplastic polymer of formula I is grafted to the thermoplastic polymer of formula II.

A third aspect of the present application relates to a method of forming a thermoplastic graft copolymer. The method includes:
mixing one or more thermoplastic polymers of formula I:

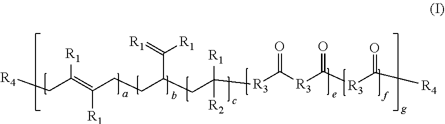

with a branched chain thermoplastic polymer of formula II:

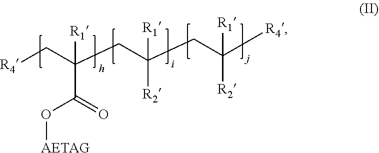

where
R¹ and R¹′ are independently selected at each occurrence thereof from the group consisting of H and methyl;
R² and R²′ are independently selected at each occurrence thereof from the group consisting of H, OH, halogen, —COOR⁵, —C(O)NR⁵R⁶, C₁-C₂₃ alkyl, and benzyl, where the C₁-C₂₃ alkyl can be optionally substituted with an aryl, heteroaryl, or heterocyclyl;
R³ is independently selected at each occurrence thereof from the group consisting of —X—R⁷—X—, C₁-C₂₃ alkylene, arylene, and heteroarylene;
R⁴ and R⁴′ are independently selected at each occurrence thereof from the group consisting of C₁-C₂₃ alkyl and benzyl, where the C₁-C₂₃ alkyl can be optionally substituted with an aryl, heteroaryl, heterocyclyl, carboxylic acid, oxirane, ester, thioester, or carbonotrithioate;
R⁵ and R⁶ are independently selected at each occurrence thereof from the group consisting of H and C₁₋₁₀ alkyl, hydoxyalkyl, or alkyloxirane;
R⁷ is independently selected at each occurrence thereof from the group consisting of

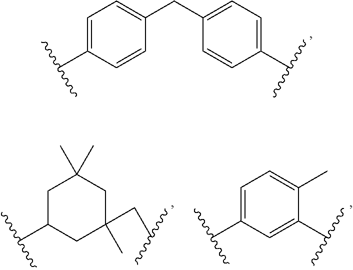

C₁₋₂₃ alkyl, where the C₁-C₂₃ alkyl can be optionally substituted with an aryl, heteroaryl, or heterocyclyl;
X is independently selected at each occurrence thereof from the group consisting of methylene, —NH—, or —O—.
AETAG is a (meth)acrylated epoxidized triacyl glyceride;
a, b, c, d, e, and f represent number average degrees of polymerization for repeat units of formula I that are distributed throughout the polymer chain in a statistically defined manner;
a, b, c, d, e, and f range from 0 to 100,000, where a+b+c+d+e+f ranges from 100 to 200,000;
g ranges from 1 to 5;
h, i, and j represent number average degrees of polymerization for repeat units of formula II that are distributed throughout the polymer chain in a statistically defined manner;
h ranges from 100 to 100,000; and
i and j range from 0 to 100,000, where the thermoplastic polymer of formula I is grafted to the thermoplastic polymer of formula II;
heating the blend; and
extruding the heated blend to form a thermoplastic graft copolymer.

Polylactide is a compostable bioderived polyester that has gained popularity as a replacement for petroleum based thermoplastics. Engineering thermoplastics are used in applications requiring high impact strength and ductility. While petroleum based thermoplastics fit this criteria, PLA is brittle and unsuitable for these uses. Advances in toughening PLA can be seen using polymer blends where a reactive impact modifier is used to concentrate the stress at low Tg rubbers and dissipate the energy. The majority of these impact modifiers however are petroleum based and not bioderived. This application shows that PLA can be significantly enhanced with the addition of a bioderived reactive soybean based elastomer. As little as 10 wt % poly(acrylated epoxidized high oleic soybean oil) (PAHOESO) derivatives can exhibit tensile toughness and notched izod impact strength over an order of magnitude higher than pristine PLA with only minute reductions in the elastic modulus. A series of PLA blends containing PAHOESO based polymers were synthesized at varying molecular weights, polymer loadings, and polymer architectures. The toughness was shown to increase as the morphology changed from spherical to rod-like. Using TEM, the largest degree of toughening is observed when small rod-like micelles are formed and well dispersed throughout the PLA matrix. This new series of biobased polymers along with the facilitation of compatibilized micelles suggest a cost-effective strategy for toughening brittle thermoplastics with bioderived polymers.

PAEHOSO, a thermoplastic elastomer useful for applications including polymer modification of asphalt, retains residual vinyl, alcohol, ester, and epoxy functionality that provides an unusual versatility for chemical conjugation. In this application, pendant vinyl groups of PAEHOSO are reacted with those of the poly(butadiene) sequences in commercially available SBS. With respect to polymer modification of asphalt, the resultant hybrid material has numerous beneficial properties compared to SBS or PAEHOSO alone. The experiments with asphalt binder show that the SBS/PAEHOSO hybrid can be pelletized, facilitating transport, storage, and handling of the material compared to the previous work with PAEHOSO. SBS/PAEHOSO can be homogeneously dispersed in asphalt under mild temperature and shear conditions, reducing energy consumption and capital equipment requirements, enabling a wide range of asphalt terminal suppliers and even contractors to formulate their own polymer modified asphalt grades.

### BRIEF DESCRIPTION OF THE DRAWINGS

FIG. 1 is a schematic illustration depicting the localization of Formula I-graft-Formula II polymers at the interface between Formula I-rich and Formula III-rich domains. On the left, the exemplary Formula I polymer is polybutadiene; on the right Formula III is a polylactide or PLA. PAEHOSO, depicted with its characteristic branched chain architecture, appears in the center as Formula II. Graft bonds are illustrated in the insets, mediated through vinyl-vinyl coupling on the left (with polybutadiene), and acid-epoxy coupling on the right (with polylactide).

FIG. 2 shows the ¹H NMR of acrylated epoxidized high oleic soybean oil (AESO) and poly(acrylated epoxidized high oleic soybean oil) (PAEHOSO).

FIG. 3 is the simplified reaction scheme to produce PAHBLO-A. PAHBLO-A refers to a poly(acrylated high oleic block copolymer), namely poly(glycidal methacrylate-block-acrylated epoxidized high oleic soybean oil).

FIG. 4 shows the polymer architectures of hompolymer poly(methacrylated epoxidized high oleic soybean oil) (PMAEHOSO). PMMA-stat-PAEHOSO are polymers formed from the blend of PLA with poly(methyl methacrylate-stat-acrylated epoxidized high oleic soybean oil) (PMMA/PAEHOSO). PGMA-block-PAEHOSO are polymers formed from the blend of PLA and poly(glycidyl methacrylate-block-acrylated epoxidized high oleic soybean oil) (PGMA-PAEHOSO).

FIG. 5 is the Gel Permeation Chromatography (GPC) chromatogram of PAHBLO-L showing the molecular weight growth of the block copolymer with a resultant Mn of 20 kDa and a PDI of 3.8.

FIG. 6 is the TEM image of the phase separated morphology in the PAHBLO-H diblock copolymer where the PGMA is phase separated as 200 nm spheres.

FIGS. 7A-7D shows TEM images of compatibilized blends. FIG. 7A is PLA; FIG. 7B is BABS-C; FIG. 7C is PAHCO-A; FIG. 7D is PAHBLO-L. All Tensile bars are shown post deformation with a TEM image showing the microstructure for each respective polymer blend

FIG. 8 is the TEM image of PAHBLO-L post-deformation showing a macromolecular structure with propagation of cavitation throughout the rod-like micelle.

FIG. 9 is a plot of the stress strain curves showing the behavior of the PLA blended with increasing PAHBLO-L loadings. Each specimen was tested under amorphous conditions.

FIG. 10 is a graph of the impact strength of samples blended with PAHBLO-L at different loadings. Each sample was annealed for 2.5 hours at 90° C.

FIG. 11 is a photograph showing hinge breaks rather than complete breaks after the incorporation of PAHBLO-L into PLA.

FIG. 12 is a cartoon comparing the morphology of a typical SBS-modified asphalt (left) with that of an asphalt modified with a blend of a polymer of Formula I (exemplified as SBS), a polymer of Formula II (exemplified as PAEHOSO), and the graft polymers formed by chemical junctions between polymers of Formula I and Formula II. In a traditional polymer modified asphalt, SBS chains self-assemble into micelles with polystyrene cores (dark gray) and polybutadiene coronae (light gray). Some SBS chains bridge neighboring micelles to impart elasticity to the asphalt (highlighted chains in the wagon wheel configuration). In the SBS+PAEHOSO+PAEHOSO-graft-SBS modified asphalt (right), SBS chains self-assemble as usual, with enhanced elasticity provided through grafted PAEHOSO molecules (diagramed as branched chains) that establish intermicellar connectivity.

### DETAILED DESCRIPTION

The present application relates to thermoplastic graft copolymer including:
one or more thermoplastic polymers of formula I:

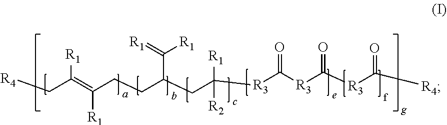

and
a branched chain thermoplastic polymer of formula II:

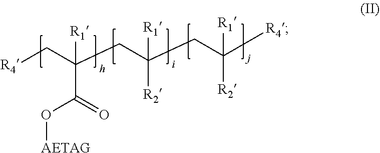

where
R¹ and R¹′ are independently selected at each occurrence thereof from the group consisting of H and methyl;
R² and R²′ are independently selected at each occurrence thereof from the group consisting of H, OH, halogen, —COOR⁵, —C(O)NR⁵R⁶, C₁-C₂₃ alkyl, and benzyl, where the C₁-C₂₃ alkyl can be optionally substituted with an aryl, heteroaryl, or heterocyclyl;
R³ is independently selected at each occurrence thereof from the group consisting of —X—R⁷—X—, C₁-C₂₃ alkylene, arylene, and heteroarylene;
R⁴ and R⁴′ are independently selected at each occurrence thereof from the group consisting of C₁-C₂₃ alkyl and benzyl, where the C₁-C₂₃ alkyl can be optionally substituted with an aryl, heteroaryl, heterocyclyl, carboxylic acid, oxirane, ester, thioester, or carbonotrithioate;
R⁵ and R⁶ are independently selected at each occurrence thereof from the group consisting of H and C₁₋₁₀ alkyl, hydoxyalkyl, or alkyloxirane;
R⁷ is independently selected at each occurrence thereof from the group consisting of

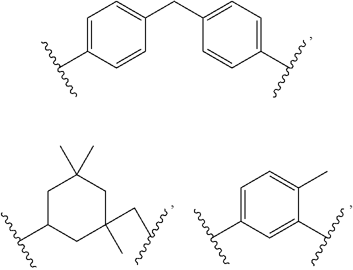

C₁₋₂₃ alkyl, where the C₁-C₂₃ alkyl can be optionally substituted with an aryl, heteroaryl, or heterocyclyl;
X is independently selected at each occurrence thereof from the group consisting of methylene, —NH—, or —O—.
AETAG is a (meth)acrylated epoxidized triacyl glyceride;
a, b, c, d, e, and f represent number average degrees of polymerization for repeat units of formula I that are distributed throughout the polymer chain in a statistically defined manner;
a, b, c, d, e, and f range from 0 to 100,000, where a+b+c+d+e+f ranges from 100 to 200,000;
g ranges from 1 to 5;
h, i, and j represent number average degrees of polymerization for repeat units of formula II that are distributed throughout the polymer chain in a statistically defined manner;
h ranges from 100 to 100,000; and
i and j range from 0 to 100,000, where the thermoplastic polymer of formula I is grafted to the thermoplastic polymer of formula II.

The term “copolymer” refers to a polymer derived from more than one species of monomer.

As used herein “graft copolymers” are copolymers having a main chain and one or more side chains that are constitutionally different from the main chain. Typically, the graft copolymers of the present application contain main and side chains that are constitutionally different from one another, because they are derived from different characteristic species of monomer (e.g., because a monomer found in the main chain is not found in the side chains and/or vice versa).

The term “statistically defined manner” refers to the repeat unit sequence distribution (RUSD) of the polymer, which is determined by the polymerization chemistry, the number and nature of comonomers, and the reaction conditions under which the polymer is formed. For any polymer, the RUSD can be represented by a probability function Pᵢ(j) that indicates the likelihood that the identity of the repeat unit at location j along the chain contour is i. Common RUSD classifications include, but are not limited to, random (Pᵢ=constant) and block (e.g., Pᵢ(j<f)=0 and Pᵢ(j≥f)=1 given fixed contour coordinate f). RUSD prediction and measurement are discussed in most polymer chemistry texts, e.g. Hiemenz and Lodge, Polymer Chemistry, 2^{nd} Ed., Boca Raton Fl. CRC Press (2007), which is hereby incorporated by reference in its entirety.

The term “block copolymer” or “block polymer” refers to a macromolecule consisting of long sequences of different repeat units. Exemplary block polymers include, but are not limited to AₙBₘ, AₙBₘAₖ, AₙBₘCₖ, or AₙBₘCₖAₙ, wherein A, B, and C represent the different monomers, and n, m, and k are the number of monomers present in each block.

The term “glass transition temperature” or “Tg” refers to the temperature at which a polymeric material transitions from a glassy state (e.g., brittleness, stiffness, and rigidity) to a rubbery state (e.g., flexible and elastomeric). The Tg can be determined, for example, using techniques such as Differential Scanning Calorimetry (DSC) or Dynamic Mechanical Analysis (DMA).

As used herein, the term “thermoplastic” refers to polymeric material that flows when heated and then returns to its original state when cooled to room temperature. However, under some conditions (e.g., applications where solvent resistance or higher temperature performance is desired), the thermoplastic polymers can be covalently crosslinked. Upon crosslinking, the materials lose their thermoplastic characteristics and become thermoset materials.

As used herein, the term “thermoset” refers to polymeric materials that become infusible and insoluble upon heating and that do not return to their original chemical state upon cooling. Thermoset materials tend to be insoluble and resistant to flow.

As used herein, the term “engineering thermoplastics” refers to a group of polymers that possess a balance of properties comprising strength, stiffness, impact resistance, and long term dimensional stability that make them useful as structural materials.

In some embodiment of the present application the thermoplastic polymer of formula (I) is a copolymer or terpolymer. The polymers of formula (I) may be styrene-butadiene-styrene, styrene-isoprene, ethylene-vinyl acetate polymers, and combinations thereof.

The thermoplastic polymers of formula I may be formed from monomers containing a vinyl, diene, or amide moiety. Some exemplary polymer of formula (I) include, but are not limited to polybutadienes, polyisoprenes, polystyrenes, polyacrylates, acrylamides, vinyl polymers, polyamides, and combinations thereof.

Exemplary vinyl aromatic monomers include styrene, a-methyl styrene, t-butyl styrene, vinyl xylene, vinyl naphthalene, vinyl pyridine, divinyl benzene, N-vinyl heteroaromatics (such as 4-vinylimidazole (Vim), N-vinylcarbazole (NVC), N-vinylpyrrolidone, etc.). Other exemplary vinyls include vinyl esters (such as vinyl acetate (VAc), vinyl butyrate (VB), vinyl benzoate (VBz)), N-vinyl amides and imides (such as N-vinylcaprolactam (NVCL), N-vinylpyrrolidone (NVP), N-vinylphthalimide (NVPI), etc.), vinylsulfonates (such as 1-butyl ethenesulfonate (BES), neopentyl ethenesulfonate (NES), etc.), vinylphosphonic acid (VPA), haloolefins (such as vinylidene fluoride (VF2)), etc.

Exemplary nonaromatic vinyl monomers include ethylene, propylene, vinyl chloride, and vinyl acetate.

Exemplary diolefins monomers include butadiene, isoprene, etc.

Exemplary methacrylate monomers include C1-C6 (meth)acrylate (i.e., methyl methacrylate, ethyl methacrylate, propyl (meth)acrylate, butyl (meth)acrylate, isobutyl methacrylate, heptyl (meth)acrylate, or hexyl (meth)acrylate), 2-(acetoacetoxy)ethyl methacrylate (AAEMA), 2-aminoethyl methacrylate (hydrochloride) (AEMA), allyl methacrylate (AMA), cholesteryl methacrylate (CMA), t-butyldimethylsilyl methacrylate (BDSMA), (diethylene glycol monomethyl ether) methacrylate (DEGMA), 2-(dimethylamino)ethyl methacrylate (DMAEMA), (ethylene glycol monomethyl ether) methacrylate (EGMA), 2-hydroxyethyl methacrylate (HEMA), dodecyl methacrylate (LMA), methacryloyloxyethyl phosphorylcholine (MPC), (poly(ethylene glycol) monomethyl ether) methacrylate (PEGMA), pentafluorophenyl methacrylate (PFPMA), 2 (trimethylamonium)ethyl methacrylate (TMAEMA), 3-(trimethylamonium)propyl methacrylate (TMAPMA), triphenylmethyl methacrylate (TPMMA), etc. Other exemplary acrylates include 2-(acryloyloxy)ethyl phosphate (AEP), butyl acrylate (BA), 3-chloropropyl acrylate (CPA), dodecyl acrylate (DA), di(ethylene glycol) 2-ethylhexyl ether acrylate (DEHEA), 2-(dimethylamino)ethyl acrylate (DMAEA), ethyl acrylate (EA), ethyl a-acetoxyacrylate (EAA), ethoxyethyl acrylate (EEA), 2-ethylhexyl acrylate (EHA), isobornyl acrylate (iBoA), methyl acrylate (MA), propargyl acrylate (PA), (poly(ethylene glycol) monomethyl ether) acrylate (PEGA), tert-butyl acrylate (tBA), etc. Exemplary methacrylamides include N-(2-aminoethyl)methacrylamide (hydrochloride) (AEMAm) and N-(3-aminopropyl)methacrylamide (hydrochloride) (APMAm), N (2 (dimethylamino)ethyl)acrylamide (DEAPMAm), N-(3-(dimethylamino)propyl)methacrylamide (hydrochloride) (DMAPMAm), etc. Other exemplary acrylamides include acrylamide (Am), 2-acrylamido-2-methylpropanesulfonic acid sodium salt (AMPS), N-benzylacrylamide (BzAm), N-cyclohexylacrylamide (CHAm), diacetone acrylamide (N-(1,1-dimethyl-3-oxobutyl) acrylamide) (DAAm), N,N-diethylacrylamide (DEAm), N,N-dimethylacrylamide (DMAm), N (2 (dimethylamino)ethyl)acrylamide (DMAEAm), N-isopropylacrylamide (NIPAm), N octylacrylamide (OAm), etc.

Exemplary acrylamide monomers include acrylamide (Am), 2-acrylamido-2-methylpropanesulfonic acid sodium salt (AMPS), N-benzylacrylamide (BzAm), N-cyclohexylacrylamide (CHAm), diacetone acrylamide (N-(1,1-dimethyl-3-oxobutyl) acrylamide) (DAAm), N,N-diethylacrylamide (DEAm), N,N-dimethylacrylamide (DMAm), N (2 (dimethylamino)ethyl)acrylamide (DMAEAm), N-isopropylacrylamide (NIPAm), N octylacrylamide (OAm), etc.

A more extensive list of exemplary methacrylate monomers, acrylate monomers, methacrylamide monomers, acrylamide monomers, styrenic monomers, diene monomers, vinyl monomers, monomers with reactive functionality, and crosslinking monomers that are suitable for usage as the radically polymerizable monomers herein has been described in Moad et al., “Living Radical Polymerization by the Raft Process—a Third Update,” Australian Journal of Chemistry 65: 985-1076 (2012), which is hereby incorporated by reference in its entirety.

Some specific examples of the polymers of formula (I) of the present application include, but are not limited to, polyamide-6,6, polyamide-6,12, polyamide-6, polypropylene, polyvinyl chloride, poly methyl methacrylate, and polytetrafluoroethylene.

Commodities such as soybeans provide an abundant, low-cost option as an alternative feedstock for petroleum-based polymers. Soybean oil-based polymers can provide a wide range of characteristics ranging from soft and elastic to hard and rigid depending on the monomer used. Soybean oil-based monomers are unique due to their variable saturation composition, which enables them to be multi-functional. These multi-functional chemical moieties allow soybean polymers to have acrylic, alcohol, ester, and epoxy functionality, which can be exploited using reactive extrusion with various polyester or polydiene polymers.

Soybean Oil (SBO) is the most abundant vegetable oil, which accounts for almost 30% of the world's vegetable oil supply. SBO is particularly suitable for polymerization, because it possesses multiple carbon-carbon double bonds that allow for modifications such as conjugation of the double bonds, etc.

Vegetable oils and animal fats are mixtures of triglycerides. A representative structure of a triglyceride is shown as below:

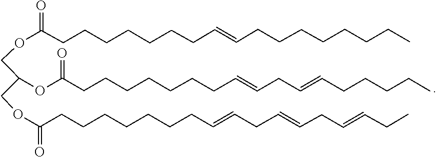 [SMILES: CC/C=C/C/C=C/C/C=C/CCCCCCCC(=O)OCC(COC(=O)CCCCCCC/C=C/CCCCCCCC)OC(=O)CCCCCCC/C=C/C/C=C/CCCCC]

A typical triglyceride structure contains a number of double bonds that may serve as candidates for polymerization. Various soybean cultivars express a variety of triglyceride compositions in their oils. Different strains of soybeans may be appropriately selected based on the triglyceride compositions to enhance the block copolymer yield and properties.

Renewable source-derived fats and oils comprise glycerol triesters of fatty acids. These are commonly referred to as “triglycerides” or “triacylglycerols” (TAG). Fats and oils are usually denoted by their biological source and contain several different fatty acids typical for each source. For example, the predominant fatty acids of soybean oil are the unsaturated fatty acids oleic acid, linoleic acid, and linolenic acid, and the saturated fatty acids palmitic acid and stearic acid. Other fatty acids are present at low levels. Triglycerides are the main component of natural oils and are composed of three fatty acids groups connected by a glycerol center.

“Triglycerides,” as defined herein, may refer to any unmodified triglycerides naturally existent in plant oil or animal oil or animal fat as well as any derivatives of unmodified triglycerides, such as synthetically derived triglycerides. The naturally existent parent oil may also contain derivatives of triglycerides, such as free fatty acids. An unmodified triglyceride may include any ester derived from glycerol with three similar or different fatty acids. Triglyceride derivatives may include any modified triglycerides that contain conjugated systems (i.e. a system of connected p-orbitals with delocalized electrons in triglycerides). Such conjugated systems increase the reactivity of triglycerides towards propagation reactions. Useful conjugated triglycerides include, but are not limited to, triglyceride derivatives containing conjugated double bonds or conjugated systems formed by acrylate groups.

Unsaturated fatty acids are susceptible to epoxidation to form fatty acids bearing epoxide rings. Thus, triglycerides containing unsaturated fatty acids can be subjected to epoxidation to form epoxidized triglycerides in which one, two, or all three fatty acids bear at least one epoxide ring. Diglycerides (diacylglycerols, “DAG”) can be obtained when one fatty acid is removed from a triglyceride, typically by hydrolysis; monoglycerides (monoacylglycerols, “MAG”) may be obtained when two fatty acids are removed from a triglyceride.

The term “epoxide” or “oxirane” includes an epoxide ring (i.e., group) as shown below:

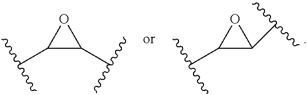 [SMILES: *C1OC1* ; *C1OC1*]

Epoxidized triglycerides can be found as such in nature, for instance in Vernonia plants, or can be conveniently synthesized from more common unsaturated oils by using a standard epoxidation process. See U.S. Patent Publ. No. 20120156484 to Vendamme et al., which is hereby incorporated by reference in its entirety.

The compounds described herein may contain one or more epoxide (oxirane) rings, and, unless specified otherwise, it is intended that the compounds include both cis- or trans-isomers and mixtures thereof. When the compounds described herein contain olefinic double bonds or other centers of geometric asymmetry, and, unless specified otherwise, it is intended that the compounds include both E and Z geometric isomers.

The oxirane oxygen content (also referred to herein as % oxirane oxygen or wt % of oxirane) of may be determined by using Official Method, Standard Cd 9-57 of the American Oil Chemists' Society (“Oxirane Oxygen in Epoxidized Materials” Official Method Cd 9-57 by the American Oil Chemist' Society (Reapproved 2017), which is hereby incorporated by reference in its entirety).

$$Oxirane oxygen , \% = \frac{mL HBr to titrate test portion \times M \times 1.6}{mass of test portion , g} \qquad Equation 1$$

$$Where$$

$$M = Molarity of HBr solution$$

For example, oxirane oxygen content for epoxidized soybean oil may be about 7.2% and for sub-epoxidized soybean oil may be about 4.5%. The functionality is the number of epoxide groups per molecule. The functionality of epoxidized soybean oil in accordance with the present application may be approximately 4.5 and sub-epoxidized soybean oil may be approximately 2.1. The sub-epoxidized soybean oil in accordance with the present application may contain between 0.1 wt % and 10 wt % of oxirane. For example, the wt % of oxirane may be about 0.5, 1, 2, 3, 4, 5, 6, 7, 8, 9, or 10 wt %.

The thermoplastic polymer of formula (II) according to the present application may be formed from a fully or partially epoxidized TAG, which means that at least one of the double bonds of the unsaturated fatty acid ester in the precursor is oxidized to an epoxy group. Such oxidations are well known in the art and can be readily accomplished in an industrial scale, e.g., by using hydrogen peroxide and a carboxylic acid (e.g., formate or acetate), or by the halohydrin method. See WO 2007062158 to Selifonov, which is hereby incorporated by reference in its entirety.

Epoxidized triglycerides are commercially available. See U.S. Patent Publ. No. 20120156484 to Vendamme et al., which is hereby incorporated by reference in its entirety. For example, epoxidized linseed oil (ELO) is available from Cognis (Düsseldorf, Germany) under the trade name DEHYSOL B316 SPEZIAL, or Arkema (King of Prussia, Pa.) under the trade name VIKOFLEX 7190. An exemplary structure of an epoxidized triglyceride of linseed oil is as follows:

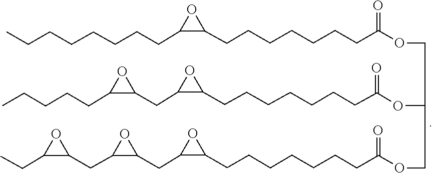

The epoxidized precursor triglycerides for forming compounds of formula (II) can be subjected to esterification reactions with polyhydric alcohols (such as sugars, sugar acids, glycerol, and glycols) to form epoxidized esters of polyols, or with monohydric alcohols (such as benzyl alcohol, methanol, ethanol, propanols, butanols, and longer alcohols), furan-containing alcohols (such as tetrahydro-2-furanmethanol and 2-furanmethanol), glycidol, and fusel oil) to form epoxidized monoesters. Alternatively, epoxidized esters of polyols or of monohydric alcohols can be obtained by subjecting the esters to epoxidation.

Renewable source derived fats and oils include algal oil, animal fat, beef tallow, borneo tallow, butterfat, camelina oil, candlefish oil, canola oil, castor oil, cocoa butter, cocoa butter substitutes, coconut oil, cod-liver oil, colza oil, coriander oil, corn oil, cottonseed oil, false flax oil, flax oil, float grease from wastewater treatment facilities, hazelnut oil, hempseed oil, herring oil, illipe fat, jatropha oil, kokum butter, lanolin, lard, linseed oil, mango kernel oil, marine oil, meadowfoam oil, menhaden oil, microbial oil, milk fat, mowrah fat, mustard oil, mutton tallow, neat's foot oil, olive oil, orange roughy oil, palm oil, palm kernel oil, palm kernel olein, palm kernel stearin, palm olein, palm stearin, peanut oil, phulwara butter, pile herd oil, pork lard, radish oil, ramtil oil, rapeseed oil, rice bran oil, safflower oil, sal fat, salicornia oil, sardine oil, sasanqua oil, sesame oil, shea fat, shea butter, soybean oil, sunflower seed oil, tall oil, tallow, tigernut oil, tsubaki oil, tung oil, triacylglycerols, triolein, used cooking oil, vegetable oil, walnut oil, whale oil, white grease, yellow grease, and derivatives, conjugated derivatives, genetically-modified derivatives, and mixtures of any thereof. In one embodiment, the thermoplastic polymers of formula (II) may be derived from sources selected from the group consisting of fish oil, animal oil, vegetable oil, synthetic and genetically-modified plant oils, and mixtures thereof. Examples of vegetable oil include rapeseed oil, safflower oil, canola oil, castor oil, sunflower oil, linseed oil, soybean oil, and corn oil.

These triglycerides or triglyceride mixtures are typically plant oils. Suitable plant oils useful for the triacyl glyceride of the (meth)acrylated epoxidized triacyl glyceride of the branched chain thermoplastic polymer of formula II include, but are not limited to, a variety of vegetable oils such as soybean oil, peanut oil, walnut oil, palm oil, palm kernel oil, sesame oil, sunflower oil, safflower oil, rapeseed oil, linseed oil, flax seed oil, colza oil, coconut oil, corn oil, cottonseed oil, olive oil, castor oil, false flax oil, hemp oil, mustard oil, radish oil, ramtil oil, rice bran oil, salicornia oil, tigernut oil, tung oil, etc., and mixtures thereof. Typical vegetable oils used herein includes soybean oil, linseed oil, corn oil, flax seed oil, or rapeseed oil.

The poly(acrylated epoxidized high oleic soybean oil) (PAEHOSO) used in the exemplary copolymers of the present application may be formed using controlled radical polymerization (also known as living polymerization) of acrylated epoxidized high oleic soybean oil. Exemplary controlled free radical polymerization reactions that can be used for the formation of the thermoplastic polymers of formula (II) include atom transfer radical polymerization (ATRP), reversible addition-fragmentation chain transfer (RAFT) polymerization, or nitroxide mediated free radical polymerization (NMP). Examples of RAFT polymerization methods useful for forming the thermoplastic polymers of formula (II) can be found in U.S. Pat. No. 9,650,463 to Cochran et al., which is hereby incorporated by reference in its entirety. Examples of ATRP polymerization methods useful for forming the thermoplastic polymers of formula (II) can be found in U.S. Pat. No. 9,932,435 to Cochran et al., which is hereby incorporated by reference in its entirety.

In some embodiments of the present application the thermoplastic polymer of formula II has at least one occurrence of R⁴′ selected from a group selected from thioester, carbonotrithioate, xanthate, and dithiocarbamate.

In some embodiments of the present application, the thermoplastic polymer of formula II has a number average molecular weight ranging from 10 kDa to 20000 kDa. For example, the molecular weight may range from about 10 kDa, 50 kDa, 100 kDa, 150 kDa, 200 kDa, 250 kDa, 300 kDa, 350 kDa, 400 kDa, 450 kDa, 500 kDa, 550 kDa, 600 kDa, 650 kDa, 700 kDa, 750 kDa, 800 kDa, 850 kDa, 900 kDa, or 950 kDa to 100 kDa, 150 kDa, 200 kDa, 250 kDa, 300 kDa, 350 kDa, 400 kDa, 450 kDa, 500 kDa, 550 kDa, 600 kDa, 650 kDa, 700 kDa, 750 kDa, 800 kDa, 850 kDa, 900 kDa, or 950 kDa up to about 50 kDa, 100 kDa, 150 kDa, 200 kDa, 250 kDa, 300 kDa, 350 kDa, 400 kDa, 450 kDa, 500 kDa, 550 kDa, 600 kDa, 650 kDa, 700 kDa, 750 kDa, 800 kDa, 850 kDa, 900 kDa, or 950 kDa to 100 kDa, 150 kDa, 200 kDa, 250 kDa, 300 kDa, 350 kDa, 400 kDa, 450 kDa, 500 kDa, 550 kDa, 600 kDa, 650 kDa, 700 kDa, 750 kDa, 800 kDa, 850 kDa, 900 kDa, 950 kDa, 1000 kDa, 1250 kDa, 1500 kDa, 1750 kDa, 2000 kDa, 2250 kDa, 2500 kDa, 2750 kDa, 3000 kDa, 3250 kDa, 3500 kDa, 3750 kDa, 4000 kDa, 4250 kDa, 4500 kDa, 4750 kDa, 5000 kDa, 5250 kDa, 5500 kDa, 5750 kDa, 6000 kDa, 6250 kDa, 6500 kDa, 6750 kDa, 7000 kDa, 7250 kDa, 7500 kDa, 7750 kDa, 8000 kDa, 8250 kDa, 8500 kDa, 8750 kDa, 9000 kDa, 9250 kDa, 9500 kDa, 9750 kDa, or 10000 kDa. The molecular weight may range from 10 kDa to 15000 kDa, 10 kDa to 10000 kDa, 50 kDa to 10000 kDa, 100 kDa to 10000 kDa, 200 kDa to 10000 kDa, 300 kDa to 10000 kDa, 400 kDa to 10000 kDa, 500 kDa to 10000 kDa, 600 kDa to 10000 kDa, 700 kDa to 10000 kDa, 800 kDa to 10000 kDa, 900 kDa to 10000 kDa, 1000 kDa to 10000 kDa, 100 kDa to 9000 kDa, 500 kDa to 9000 kDa, 500 kDa to 8000 kDa, 500 kDa to 7000 kDa, 500 kDa to 6000 kDa, 500 kDa to 5000 kDa, 500 kDa to 4000 kDa, 500 kDa to 3000 kDa, or 500 kDa to 2000 kDa.

The thermoplastic graft copolymer of the present application may also include a thermoplastic polymer of formula III:

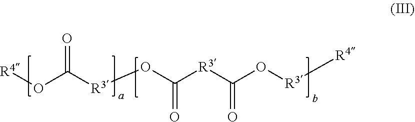

where
R³′ is independently selected at each occurrence thereof from the group consisting of C₁-C₂₃ alkylene, arylene, and heteroarylene;
R⁴″ is independently selected at each occurrence thereof from the group consisting of C₁-C₂₃ alkyl, and benzyl, where the C₁-C₂₃ alkyl can be optionally substituted with an aryl, heteroaryl, heterocyclyl, carboxylic acid, oxirane, ester, thioester, or carbonotrithioate;
a and b represent number average degrees of polymerization for repeat units of formula I that are distributed throughout the polymer chain in a statistically defined manner; and
a and b range from 0 to 100,000, wherein a+b ranges from 100 to 200,000, where the thermoplastic polymer of formula III is grafted to the thermoplastic polymer of formula I and the thermoplastic polymer of formula II.

Exemplary polymers useful as the thermoplastic polymer of formula (III) include, but are not limited to, polylactide, poly butylene succinate, poly hydroxyalkanoates, polyethylene terephthalate, poly butylene terephthalate, polypropylene furanoate, polyethylene furanoate, and combinations thereof.

As used herein the term “polylactic acid”, or “polylactide” (PLA) includes poly(D-lactide), poly(L-lactide), poly(DL-lactide), and combinations thereof. PLA in general has a formula of:

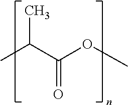

PLAs are polymers produced by the ring opening polymerization of lactide or the polycondensation of lactic acid, which is typically derived from a starch from corn or potatoes.

The polylactic acid may be formed by known methods, such as dehydration condensation of lactic acid (see, U.S. Pat. No. 5,310,865 to Enomoto et al., which is hereby incorporated by reference in its entirety) or synthesis of a cyclic lactide from lactic acid followed by ring opening polymerization of the cyclic lactide (see, U.S. Pat. No. 2,758,987 to Ito et al., which is hereby incorporated by reference in its entirety), for example. Such processes may utilize catalysts for polylactic acid formation, such as tin compounds (e.g., tin octylate), titanium compounds (e.g., tetraisopropyl titanate), zirconium compounds (e.g., zirconium isopropoxide), antimony compounds (e.g., antimony trioxide), or combinations thereof, for example.

Poly(hydroxyalkanoates) (PHAs) are well-known polyester compounds produced by a variety of microorganisms, such as bacteria and algae. A PHA polyester can include the same or different repeating units, depending upon the choice of carbon source substrates and fermentation conditions employed in the production of the PHA.

The poly(hydroxyalkanoates) used in the present application may be obtained from a biological source or from a chemical synthesis. The biological source can be a microorganism, a higher organism such as a plant, or a genetically modified bioreactor such as a host cell that can be a prokaryote or a eukaryote. Methods used to produce PHAs biologically are known in the art such as, for example, those methods discussed in U.S. Pat. No. 4,910,145 to Holmes et al.; and U.S. Pat. Nos. 5,245,023; 5,250,430; 5,480,794; 5,512,669; and 5,534,432 to Peoples et al., which are hereby incorporated by reference in their entirety. Methods of producing PHAs through chemical synthesis include, but are not limited to, ring-opening polymerization of β-lactone monomers and condensation polymerization of esters of 3-hydroxy alkanioc acids, each of which are discussed in U.S. Pat. No. 6,610,764 to Martin et al., and U.S. Pat. No. 5,563,239 to Hubbs et al., respectively, which are hereby incorporated by reference in their entirety. Poly(hydroxyalkanoates) generally are formed from hydroxyacid monomeric units or derivatives thereof. These include, for example, polylactic acid, polyhydroxybutyrate, polyhydroxyvalerate, polycaprolactone and the like.

Suitable poly(hydroxyalkanoates) may be represented by the formula:

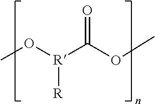

where each occurrence of R and R′ in the polymer chain is independently selected from an alkyl moiety that may be linear or branched, having from 1 to 20 carbon atoms, for example from 1 to 12 carbon atoms; and n is an integer such that the ester is polymeric (e.g., n can range from 10, 20, 30, 40, 50, 60, 70, 80, 90, or 100 to 100,000). The poly(hydroxyalkanoates) may be R-poly(hydroxyalkonates), S-poly(hydroxyalkonates), or a combination thereof.

Useful poly(hydroxyalkanoates) include, for example, homo- and copolymers of poly(3-hydroxybutyrate), poly(4-hydroxybutyrate), poly(3-hydroxyvalerate), poly(lactic acid) (also known as polylactide), poly(3-hydroxypropanoate), poly(4-hydropentanoate), poly(3-hydroxypentanoate), poly(3-hydroxyhexanoate), poly(3-hydroxyheptanoate), poly(3-hydroxyoctanoate), polydioxanone, polycaprolactone, and polyglycolic acid (i.e. polyglycolide). Copolymers of two or more of the above hydroxy acids may also be used, for example, poly(3-hydroxybutyrate-co-3-hydroxyvalerate), poly(lactate-co-3-hydroxypropanoate), poly(glycolide-co-p-dioxanone), and poly(lactic acid-co-glycolic acid). Blends of two or more of the poly(hydroxyalkanoates) may also be used.

Polybutylene succinate (PBS) is a biodegradable aliphatic polyester that consists of polymerized units of butylene succinate, with repeating C₈H₁₂O₄ units shown below:

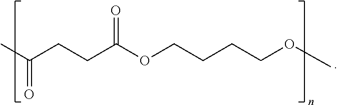

Under natural conditions, PBS can be decomposed by various microorganisms or enzymes to form carbon dioxide and water. PBS has good ductility, elongation at break, heat resistance and impact resistance.

A second aspect of the present application relates to thermoplastic polymeric mixture including:
one or more thermoplastic polymers of formula I:

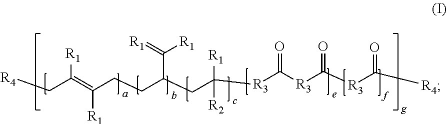

a branched chain thermoplastic polymer of formula II:

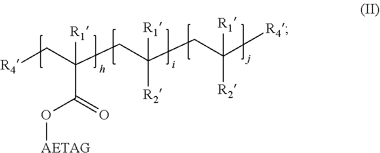

and
the graft copolymer of the present application;
   where
R¹ and R¹′ are independently selected at each occurrence thereof from the group consisting of H and methyl;
R² and R²′ are independently selected at each occurrence thereof from the group consisting of H, OH, halogen, —COOR⁵, —C(O)NR⁵R⁶, C₁-C₂₃ alkyl, and benzyl, where the C₁-C₂₃ alkyl can be optionally substituted with an aryl, heteroaryl, or heterocyclyl;
R³ is independently selected at each occurrence thereof from the group consisting of —X—R⁷—X—, C₁-C₂₃ alkylene, arylene, and heteroarylene;
R⁴ and R⁴′ are independently selected at each occurrence thereof from the group consisting of C₁-C₂₃ alkyl and benzyl, where the C₁-C₂₃ alkyl can be optionally substituted with an aryl, heteroaryl, heterocyclyl, carboxylic acid, oxirane, ester, thioester, or carbonotrithioate;
R⁵ and R⁶ are independently selected at each occurrence thereof from the group consisting of H and C₁₋₁₀ alkyl, hydoxyalkyl, or alkyloxirane;
R⁷ is independently selected at each occurrence thereof from the group consisting of

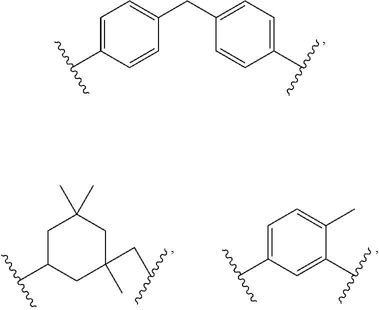

C₁₋₂₃ alkyl, where the C₁-C₂₃ alkyl can be optionally substituted with an aryl, heteroaryl, or heterocyclyl;
X is independently selected at each occurrence thereof from the group consisting of methylene, —NH—, or —O—.
AETAG is a (meth)acrylated epoxidized triacyl glyceride;
a, b, c, d, e, and f represent number average degrees of polymerization for repeat units of formula I that are distributed throughout the polymer chain in a statistically defined manner;
a, b, c, d, e, and f range from 0 to 100,000, where a+b+c+d+e+f ranges from 100 to 200,000;
g ranges from 1 to 5;
h, i, and j represent number average degrees of polymerization for repeat units of formula II that are distributed throughout the polymer chain in a statistically defined manner;
h ranges from 100 to 100,000; and
i and j range from 0 to 100,000, where the thermoplastic polymer of formula I is grafted to the thermoplastic polymer of formula II.

Additionally, the thermoplastic polymeric mixture of the present application may also include a thermoplastic polymer of formula III:

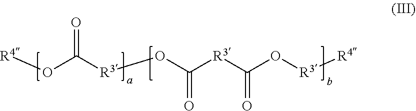

where
R³′ is independently selected at each occurrence thereof from the group consisting of C₁-C₂₃ alkylene, arylene, and heteroarylene;
R⁴″ is independently selected at each occurrence thereof from the group consisting of C₁-C₂₃ alkyl, and benzyl, where the C₁-C₂₃ alkyl can be optionally substituted with an aryl, heteroaryl, heterocyclyl, carboxylic acid, oxirane, ester, thioester, or carbonotrithioate;
a and b represent number average degrees of polymerization for repeat units of formula I that are distributed throughout the polymer chain in a statistically defined manner; and
a and b range from 0 to 100,000, wherein a+b ranges from 100 to 200,000.

In some embodiments of the present application, the thermoplastic graft copolymer forms as micelles between the thermoplastic polymers of formula I and the thermoplastic polymer of formula II. The micelles may range in diameter from 5 nm to 2000 nm. The micelles act as compatabilizers between the bulk of the thermoplastic polymer of formula (I) and the thermoplastic polymer of formula (II).

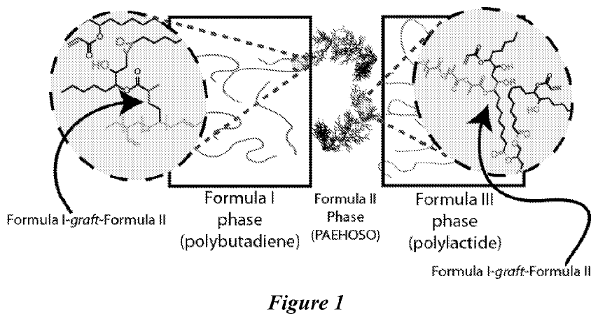

Much like small molecule surfactants that reduce the energy of the oil/water interface to yield emulsions, heterogeneous copolymers like block or graft copolymers contain two or more thermodynamically distinct repeat unit sequences. In the simplest case of an AB diblock copolymer, the “A” component is thermodynamically miscible with A-like polymers whereas the “B” component is compatible with B-like copolymers. In A+B+AB mixtures, the Gibbs energy of the mixture is often minimized when spherical droplets of “B” are dispersed throughout an “A” matrix, with the AB copolymers localizing in the AB interphase region to minimize the interfacial energy. A book chapter by Gohy provides a thorough review of these phenomena (Gohy, Jean-François. “Block Copolymer Micelles,” Block Copolymers II, Springer, Berlin, Heidelberg, p 65-136 (2005), which is hereby incorporated by reference in its entirety). In the present application, the graft copolymers play an analogous role to promote the dispersion of polymers of formula (II) throughout the polymer of formula (I) matrix. FIG. 1 depicts an example of the domain separation of a thermoplastic polymeric mixture that includes polymers of formula (I), polymers of formula (II) and polymers of formula (III).

The thermoplastic polymeric mixture of the present application may further contain a plasticizer. Primary plasticizers have been reported where the plasticizers contain fatty acids derived from vegetable oils and the fatty acids are substantially fully esterified with an alcohol (monool or polyol), the fatty acids have unsaturated bonds that are substantially fully epoxidized, and the fatty acids are added substantially randomly to one or more hydroxyl sites on the alcohol. See U.S. Pat. No. 6,797,753 to Benecke et al, which is hereby incorporated by reference in its entirety. Primary plasticizers include, but are not limited to, epoxidized pentaerythritol tetrasoyate, epoxidized propylene glycol disoyate, epoxidized ethylene glycol disoyate, epoxidized methyl soyate, epoxidized sucrose octasoyate, and the epoxidized product of soybean oil interesterified with linseed oil. For example, subepoxidized soybean oil may act as a plasticizer to the copolymers of the present application.

In some embodiments of the polymeric mixture of the present application, the ratio of thermoplastic polymers of formula I and the thermoplastic polymer of formula II ranges from 1 wt % to 99 wt %.

The thermoplastic polymeric mixture has an increased tensile toughness when compared to the thermoplastic polymer of formula (I) on its own. For example, the tensile toughness may range from 2 to 200 times the toughness of the thermoplastic polymer of formula I without the branched chain thermoplastic polymer of formula II.

The thermoplastic polymeric mixture may be used in an elastomeric composition. The elastomeric compositions may be vulcanized, cross-linked, compatibilized, and/or compounded with one or more other elastomer, additive, modifier, and/or filler.

The thermoplastic polymeric mixture may be used in a toughened engineering thermoplastic composition. The engineering thermoplastic polymers of the present application may be formed into a wide variety of articles such as films, pipes, fibers (e.g., dyeable fibers), rods, containers, bags, packaging materials, and adhesives (e.g., hot melt adhesives) for example, by polymer processing techniques known to one of skill in the art, such as forming operations including film, sheet, pipe, and fiber extrusion and co-extrusion as well as blow molding, injection molding, rotary molding, and thermoforming, for example. Films include blown, oriented, or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include slit-films, monofilaments, melt spinning, solution spinning, and melt blown fiber operations for use in woven or non-woven form to make sacks, bags, rope, twine, carpet backing, carpet yarns, filters, diaper fabrics, medical garments, and geotextiles, for example. Extruded articles include medical tubing, wire and cable coatings, hot melt adhesives, sheets, such as thermoformed sheets (including profiles and plastic corrugated cardboard), geomembranes, and pond liners, for example. Molded articles include single and multilayered constructions in the form of bottles, tanks, large hollow articles, rigid food containers, and toys, for example.

The thermoplastic polymeric mixture of the present application may be formed into compositions that contain other compounds which are customary in polymer compositions. These compounds can include flame retardants, colorants, antioxidants, antiozonates, light stabilizers, fillers, foaming agents, and the like. The level of the other compounds may be from 0 to 99 weight parts based on 100 weight parts of the total weight of the thermoplastic polymeric mixture, depending on the desired end use application. If other ingredients are used, they may be mixed into the composition in the reactive melt blend, or they may be added post-reaction in a compounding step. Compounding ingredients into polymer formulations is well-known to those skilled in the art. Melt mixing equipment such as extruders, two roll mills, Banbury mixers, and the like, may be used in the compounding step.

The thermoplastic polymeric mixture may also be used in an asphalt composition. The asphalt composition is in the form of an asphalt additive, modifier, and filler.

The asphalt portion includes material in which the predominating constituents are bitumens, which occur in nature or are obtained in petroleum processing. Bitumens include solid, semisolid, or viscous substances, natural, or manufactured, composed principally of high molecular weight hydrocarbons. The asphalt portion used in the present application is not particularly limited, and various kinds of asphalts may be used in the present application.

Suitable grades of asphalt include, but are not limited to, the following: PG52-22, PG58-22, PG64-22, PG67-22, PG70-22, PG76-22, PG82-22, PG52-28, PG58-28, PG64-28, PG67-28, PG70-28, PG76-28, PG52-34, PG58-34, PG64-34, PG64-16, PG67-16, PG70-16, PG76-16, PG64-10, PG67-10, PG70-10, PG76-10, pen grade 40-50, pen grade 60-70, pen grade 85-100, pen grade 120-150, AR4000, AR8000, AC10 grade, AC20 grade, and AC30 grade (see Roberts et al., “Hot Mix Asphalt Materials, Mixture Design, and Construction,” NAPA Research and Education Foundation (2nd ed.) (1996), which is hereby incorporated by reference in its entirety).

In one embodiment, the asphalt composition exhibits an improved multiple stress creep recovery (MSCR), such as an elastic recovery ranging from 1% to 100% measured at 46° C., 52° C., 58° C., 64° C., 72° C., or 78° C. compared to an asphalt portion alone. For example, the MSCR elastic recovery range may be about 1%, about 5%, about 10%, about 20%, about 30%, about 40%, about 50%, about 60%, about 70%, about 80%, about 90%, about 95%, or about 100% at 58° C. compared to asphalt alone.

In one embodiment, the asphalt composition exhibits an improved ΔT_{c} value, such as a ΔT_{c} value ranging from −5° C. to 5° C.

The asphalt composition of the present application may optionally include an additional asphalt polymer modifier. An asphalt polymer modifier, as used in accordance with the present application, includes any polymer material including, for example, polyphosphoric acid (PPA), styrene/butadiene block copolymers (SBS), styrene/butadiene rubbers (SBR), styrene/isoprene block copolymers (SIS), ethylene/acrylate copolymers, ethylene/vinyl acetate copolymers (EVA), and mixtures thereof. Styrene-butadiene type polymers preferably include SB rubber, SBS linear type, SBS radial type, and SB sulphur linked type polymers, and the like. Other examples of polymers include polyethylenes, oxidized polyethylenes, polyolefins, PE homopolymers, and the like. The asphalt polymer modifier can include low molecular weight polymers, such as low, medium, or high density polyethylenes having a maximum viscosity of 1000 cps at 140° C. Other suitable asphalt polymer modifier would include ethylenes and polypropylenes with melting points below 140° C. Any suitable polymer or mixture of different polymers can be used in producing polymer-modified asphalt.

The thermoplastic polymeric mixture of the present application may be present in any suitable amount for the asphalt composition, for example, between about 0.1 wt % to about 99 wt %, preferably between 0.1 wt % and 50 wt %. Examples of suitable amounts of the thermoplastic polymeric mixture include less than about 0.1 wt %, about 0.1 wt %, about 0.5 wt %, about 0.75 wt %, about 1 wt %, about 2 wt %, about 3 wt %, about 4 wt %, about 5 wt %, about 6 wt %, about 7 wt %, about 8 wt %, about 9 wt %, about 10 wt %, about 11 wt %, about 12 wt %, about 13 wt %, about 14 wt %, about 15 wt %, about 16 wt %, about 17 wt %, about 18 wt %, about 19 wt %, about 20 wt %, about 21 wt %, about 22 wt %, about 23 wt %, about 24 wt %, about 25 wt %, about 30 wt %, about 35 wt %, about 40 wt %, about 45 wt %, and about 50 wt %.

In one embodiment, the composition is in the form of an asphalt mixture. The asphalt mixture may further include fiberglass and a mineral aggregate including at least one of lime dust and granular ceramic material. Mineral aggregates of the present application may include elements of less than 0.063 mm and optionally aggregates originating from recycled materials, sand with grain sizes between 0.063 mm and 2 mm, and, optionally, grit, containing grains of a size greater than 2 mm, and optionally alumino-silicates. Aluminosilicates are inorganic compounds based on aluminium and sodium silicates or other metal such as potassium or calcium silicates. Aluminosilicates reduce the viscosity of the warm-mix and are in the form of a powder and/or granulates. The term granulates refers to mineral and/or synthetic granulates, especially coated material aggregates, which are conventionally added to bituminous binders for making mixtures of materials for road construction.

In another embodiment, the composition is used in roofing shingles. For a roofing-grade asphalt material, roofing granules can be applied to a surface of a coated base material. The roofing granules can be used for ultraviolet radiation protection, coloration, impact resistance, fire resistance, another suitable purpose, or any combination thereof. The roofing granules can include inert base particles that are durable, inert inorganic mineral particles, such as andesite, boehmite, coal slag, diabase, metabasalt, nephaline syenite, quartzite, rhyodacite, rhyolite, river gravel, mullite-containing granules, another suitable inert material, or any combination thereof. See U.S. Patent Publ. No. 2013/0160674 to Hong et al., which is hereby incorporated by reference in its entirety.

The asphalt mixture may further include a hot-mix asphalt rejuvenator and/or a softening agent. Rejuvenators and softening agents have been successfully implemented to offset the high stiffness and low creep rate of aged recycled asphalt pavement (RAP) asphalt binder. Use of rejuvenators and/or softening agents has resulted in considerable improvement to low-temperature mix properties of mixtures with high RAP content (Hajj et al., “Influence of Hydrogreen Bioasphalt on Viscoelastic Properties of Reclaimed Asphalt Mixtures,” Transportation Research Record: Journal of the Transportation Research Board 2371:13-22 (2013); Shen et al., “Effects of Rejuvenating Agents on Superpave Mixtures Containing Reclaimed Asphalt Pavement,” Journal of Materials in Civil Engineering 19(5):376-384 (2007); and Zaumanis et al., “Influence of Six Rejuvenators on the Performance Properties of Reclaimed Asphalt Pavement (RAP) Binder and 100% Recycled Asphalt Mixtures,” Construction and Building Materials 71:538-550 (2014), which are hereby incorporated by reference in their entirety).

Rejuvenators and/or softening agents are chemical or bio-derived additives which typically contain a high proportion of maltenes, which serves to replenish the maltene content in the aged bitumen that has been lost as a result of oxidation leading to increased stiffness (Copeland, A., “Reclaimed Asphalt Pavement in Asphalt Mixtures: State of the Practice,” (2011), which is hereby incorporated by reference in its entirety). Binder aging is characterized by a change of the maltenes fraction into asphaltene through oxidation. The amount of asphaltene is related to the viscosity of asphalt. Firoozifar et al., “The Effect of Asphaltene on Thermal Properties of Bitumen,” Chemical Engineering Research and Design 89:2044-2048 (2011), which is hereby incorporated by reference in its entirety. The addition of maltenes helps rebalance the chemical composition of the aged bitumen, which contain a high percentage of asphaltenes (causing high stiffness and low creep rate). Rejuvenators and softening agents recreate the balance between the asphaltene and maltene by providing more maltenes and/or by allowing better dispersion of the asphaltenes (Elseifi et al., “Laboratory Evaluation of Asphalt Mixtures Containing Sustainable Technologies,” Journal of the Association of Asphalt Paving Technologists 80 (2011), which is hereby incorporated by reference in its entirety). Rejuvenators are added during mixing and are believed to diffuse within the aged bitumen imparting softening characteristics. The rejuvenator initially coats the outside of the RAP aggregates before they gradually seep into the aged bitumen layer until they diffuse through the film thickness (Carpenter et al., “Modifier Influence in the Characterization of Hot-Mix Recycled Material,” Transportation Research Record 777 (1980), which is hereby incorporated by reference in its entirety). In one embodiment, the hot-mix asphalt rejuvenator is Hydrolene 600T.

A mineral aggregate may be added to the asphalt mixture to modify its rheology and temperature susceptibility. The asphalt mixture may be mixed with mineral aggregate typically composed of sand, gravel, limestone, crushed stone, slag, and mixtures thereof. The mineral aggregate particles of the present application include calcium based aggregates, for example, limestone, siliceous based aggregates and mixtures thereof. Aggregates can be selected for asphalt paving applications based on a number of criteria, including physical properties, compatibility with the bitumen to be used in the construction process, availability, and ability to provide a finished pavement that meets the performance specifications of the pavement layer for the traffic projected over the design life of the project.

The thermoplastic polymeric mixture may be used in an adhesive composition including a tackifier and/or a plasticizer blended with the thermoplastic polymeric mixture.

Additionally, the thermoplastic polymeric mixture may be used in a vehicle tire. The tire may be vulcanized, cross-linked, compatibilized, and/or compounded with one or more other materials.

The “liquid-like” soybean based elastomer has been shown to readily dissolve into the asphalt, while enhancing the elastomeric SBS matrix within the PMAC. As previously stated, the soybean elastomer contains acrylic functionality that can be grafted onto the butadiene backbone of the SBS polymer. Grafting of the liquid soybean rubber and the SBS in an extruder has shown to be effective at enhancing both the elasticity and solubility of SBS in the asphalt binder. Preliminary results with SBS-g-PAHOESO/SESO have shown to dissolve in asphalt without extensive shear mixing and requiring only 12 hours to cure.

A third aspect of the present application relates to a method of forming a thermoplastic graft copolymer. The method includes:
mixing one or more thermoplastic polymers of formula I:

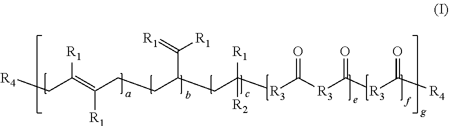

with a branched chain thermoplastic polymer of formula II:

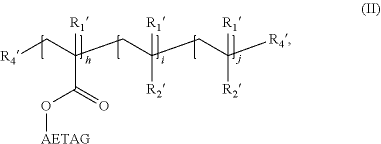

where
R¹ and R¹′ are independently selected at each occurrence thereof from the group consisting of H and methyl;
R² and R²′ are independently selected at each occurrence thereof from the group consisting of H, OH, halogen, —COOR⁵, —C(O)NR⁵R⁶, C₁-C₂₃ alkyl, and benzyl, where the C₁-C₂₃ alkyl can be optionally substituted with an aryl, heteroaryl, or heterocyclyl;
R³ is independently selected at each occurrence thereof from the group consisting of —X—R⁷—X—, C₁-C₂₃ alkylene, arylene, and heteroarylene;
R⁴ and R⁴′ are independently selected at each occurrence thereof from the group consisting of C₁-C₂₃ alkyl and benzyl, where the C₁-C₂₃ alkyl can be optionally substituted with an aryl, heteroaryl, heterocyclyl, carboxylic acid, oxirane, ester, thioester, or carbonotrithioate;
R⁵ and R⁶ are independently selected at each occurrence thereof from the group consisting of H and C₁₋₁₀ alkyl, hydoxyalkyl, or alkyloxirane;
R⁷ is independently selected at each occurrence thereof from the group consisting of

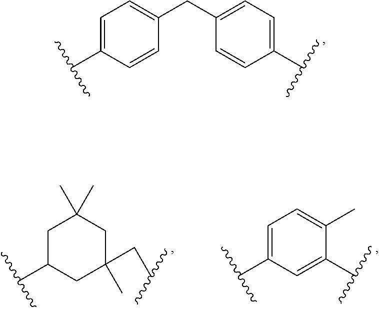

C₁₋₂₃ alkyl, where the C₁-C₂₃ alkyl can be optionally substituted with an aryl, heteroaryl, or heterocyclyl;
X is independently selected at each occurrence thereof from the group consisting of methylene, —NH—, or —O—.
AETAG is a (meth)acrylated epoxidized triacyl glyceride;
a, b, c, d, e, and f represent number average degrees of polymerization for repeat units of formula I that are distributed throughout the polymer chain in a statistically defined manner;
a, b, c, d, e, and f range from 0 to 100,000, where a+b+c+d+e+f ranges from 100 to 200,000;
g ranges from 1 to 5;
h, i, and j represent number average degrees of polymerization for repeat units of formula II that are distributed throughout the polymer chain in a statistically defined manner;
h ranges from 100 to 100,000; and
i and j range from 0 to 100,000, where the thermoplastic polymer of formula I is grafted to the thermoplastic polymer of formula II;
heating the blend; and
extruding the heated blend to form a thermoplastic graft copolymer.

In a further embodiment of the present application, the mixing of one or more mixing one or more thermoplastic polymers of formula I with a branched chain thermoplastic polymer of formula II, may also include mixing with a thermoplastic polymer of formula III:

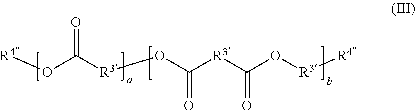

where
R³′ is independently selected at each occurrence thereof from the group consisting of C₁-C₂₃ alkylene, arylene, and heteroarylene;
R⁴″ is independently selected at each occurrence thereof from the group consisting of C₁-C₂₃ alkyl, and benzyl, where the C₁-C₂₃ alkyl can be optionally substituted with an aryl, heteroaryl, heterocyclyl, carboxylic acid, oxirane, ester, thioester, or carbonotrithioate;
a and b represent number average degrees of polymerization for repeat units of formula I that are distributed throughout the polymer chain in a statistically defined manner; and
a and b range from 0 to 100,000, wherein a+b ranges from 100 to 200,000.

The grafting reaction of the thermoplastic polymers of formula (I) and the thermoplastic polymers of formula (II), and, optionally, the thermoplastic polymers of formula (III), may be conducted in a molten state inside an extruder, such as for example a single extruder or a twin-screw extruder. Such process is often referred to as reactive extrusion or melt blending.

The thermoplastic graft copolymer of the present application may be formed via reactive extrusion. Any reactive extrusion process known in the art and literature may be used to perform the reaction. Suitable processes include melt blending in a single screw extruder, a twin screw extruder, on a two roll mill, a screw feeding injection molding machine, or in an internal mixture such as a Banbury mixer. In one embodiment of the present application, an extruder is used to melt blend the ingredients to form the thermoplastic graft polymer.

A screw extruder is a machine in which material, usually some form of plastic, is forced under pressure to flow through a contoured orifice in order to shape the material. Screw extruders are generally composed of a housing, which is usually a cylindrical barrel section, surrounding a central motor-driven screw. At a first end of the barrel is a feed housing containing a feed opening through which new material, usually plastic particles, is introduced into the barrel. The screw contains raised portions called flights having a larger radial diameter than the screw's central shaft and which are usually wrapped in a helical manner about the central shaft. The material is then conveyed by these screw flights toward the second end of the barrel through a melting zone, where the material is heated under carefully controlled conditions to melt the material and allow for the reaction of the polymers. The reacted polymer then passes through a melt-conveying zone, also called a pumping zone. The melted polymer is finally pressed through a shaped opening or die to form the extrudate.

Besides conveying material toward the die for extrusion, the screw is depended upon to perform mixing of the feed material. Very generally, mixing can be defined as a process to reduce the non-uniformity of a composition. The basic mechanism involved is to induce physical motion in the ingredients. The two types of mixing that are important in screw extruder operation are distribution and dispersion. Distributive mixing is used for the purpose of increasing the randomness of the spatial distribution of the particles without reducing the size of these particles. Dispersive mixing refers to processes that reduce the size of cohesive particles as well as randomizing their positions. In dispersive mixing, solid components, such as agglomerates, or high viscosity droplets are exposed to sufficiently high stresses to cause them to exceed their yield stress, and they are thus broken down into smaller particles. The size and shape of the agglomerates and the nature of the bonds holding the agglomerate together will determine the amount of stress required to break up the agglomerates. The applied stress can either be shear stress or elongational stress and generally, elongational stress is more efficient in achieving dispersion than is shear stress. An example of dispersive mixing is the manufacture of a color concentrate where the breakdown of pigment agglomerates below a certain critical size is crucial. An example of distributive mixing is the manufacture of miscible polymer blends, where the viscosities of the components are reasonably close together. Thus, in dispersive mixing, there will always be distributive mixing, but distributive mixing will not always produce dispersive mixing.

In screw extruders, significant mixing occurs only after the polymers have melted. Thus, the mixing zone is thought of as extending from the start of the melting zone to the end of the extrusion die. In molten polymers, the stress is determined by the product of the polymer melt viscosity and rate of deformation.

The use of single and twin screw extruders for reactive extrusion is commonly known in the art. Further disclosure of screw extruders which may be used for reactive extrusion is found in U.S. Pat. No. 8,101,108 to Otoshi; U.S. Pat. No. 7,960,473 to Kobayashi et al.; U.S. Pat. No. 6,074,084 to Kolossow; U.S. Pat. No. 5,932,159 to Rauwendaal; and U.S. Patent Application No. US20180163901 to Gopalan et al, which are hereby incorporated by reference in their entirety.

Screw feeding injection molding is a process which comprises melting a material, such as a plastic, primarily by shear heat that is dynamically generated by rotation of an extrusion screw. Screw feeding injection molding is commonly known in the art and is disclosed in U.S. Pat. No. 5,002,717 to Taniguchi; U.S. Pat. No. 2,734,226 to Willert; U.S. Pat. No. 6,676,864 to Hawley; and U.S. Pat. No. 9,931,773 to Fitzpatrick, which are hereby incorporated by reference in their entirety.

Banbury mixers consist of a kneading chamber having a closed structure, which can produce a large shear force created by a pair of rotors that are reversed in this state. Banbury mixers have been known and used extensively in the rubber industry for many years for masticating raw or uncured rubber or preparing curable rubber compositions. The general construction is described, for example, in U.S. Pat. No. 1,881,994 to Banbury, which is hereby incorporated by reference in its entirety, and improved versions of this machine have been in use for many years and are well understood by those in the rubber industry without further description. Detailed descriptions of modern Banbury machines and their use can be found in U.S. Pat. No. 3,294,720 to Beber et al.; U.S. Pat. No. 8,586,651 to Wang et al., U.S. Pat. No. 9,365,497 to Watanabe et al.; and U.S. Pat. No. 3,897,070 to Anderson et al., which are hereby incorporated by reference in their entirety.

The thermoplastic polymer of formula (I) a can be fed to the extruder in pellet form, as is commercially available. The thermoplastic polymer of formula (II) can be fed in liquid or solid form (granulates or flakes) to the extruder. Alternatively, the thermoplastic polymer of formula (II) can be coated onto the thermoplastic polymer of formula (I) before being fed into the mixer of the extruder. The thermoplastic polymer of formula (II) may be dissolved in a solvent, such as sub-epoxidized soybean oil, soybean oil, epoxidized soybean oil, methyl soyate, epoxidized methyl soyate, epoxidized soyate benzyl soyate, isoamyl soyate, vegetable oils, fatty acid methyl esters, epoxidized fatty acid methyl esters, citrate esters, other plasticizers, and mixtures thereof. The thermoplastic polymer of formula (II) in the solvent may be in a concentration ranging from 1 wt % to 99 wt %. The mixing temperature of the melt in the extruder will be a temperature sufficient to melt the polymers such that they can be processed through an extruder. The exact temperature used will depend on the melt processing temperature of the highest melting point polymers used in the blend. Melt processing temperatures may range from 100° C. to 300° C., for example from 100° C., 110° C., 120° C., 130° C., 140° C., 150° C., 160° C., 170° C., 180° C., 190° C., 200° C., 210° C., 220° C., 230° C., 240° C., 250° C., 260° C., 270° C., 280° C., or 290° C., to 110° C., 120° C., 130° C., 140° C., 150° C., 160° C., 170° C., 180° C., 190° C., 200° C., 210° C., 220° C., 230° C., 240° C., 250° C., 260° C., 270° C., 280° C., 290° C., or 300° C., as can be well understood by those skilled in the art of polymer blending. The ingredients are in the extruder for a period of time sufficient to allow for the formation of the engineering thermoplastic. This can range in time from is to 600 s. For example, the time may range from about 1 s, 10 s, 50 s, 100 s, 200 s, 300 s, 400 s, or 500 s up to about 10 s, 50 s, 100 s, 200 s, 300 s, 400 s, 500 s, or 600 s. The weight percent ratio of the thermoplastic polymers of formula (I) and the thermoplastic polymers of formula (II) may range from 1 wt % to 99 wt %. For example, the weight percent ratio of the thermoplastic polymers of formula (I) and the thermoplastic polymers of formula (II) may range from about 1 wt %, 10 wt %, 20 wt %, 30 wt %, 40 wt %, 50 wt %, 60 wt %, 70 wt %, 80 wt %, or 90 wt % up to about 10 wt %, 20 wt %, 30 wt %, 40 wt %, 50 wt %, 60 wt %, 70 wt %, 80 wt %, 90 wt %, or 99 wt %.

After exiting the extruder, the polymer can be pelletized and stored as is typical. Furthermore, the polymer would not always need to be pelletized, but rather could be extruded directly from the reaction extruder through a die into a final product profile.

The reactive extrusion technique has been used for decades as a tool to produce polymer blends and other hybrids. The process is generally viewed as efficient and effective means to bring together otherwise thermodynamically incompatible materials. High temperatures and strong shear forces drive chemical reactions over the short residence times involved to produce hybrid polymers the serve as compatibilizers to stabilize the mixture. For example, Moad provided an extensive review of methodologies employed to form polyolefin hybrids, often through free radical mediated chemistry (Moad, G. “The Synthesis of Polyolefin Graft Copolymers by Reactive Extrusion,” Prog. Polym. Sci. 24:81-142(1999), which is hereby incorporated by reference in its entirety). Polyesters are also well-suited to this processing strategy, where additives like maleic anhydride are often used to form chemical bridges with other materials like starches (Carlson, et al., Maleation of Polylactide (PLA) by Reactive Extrusion”, J. Appl. Polym. Sci. 72(4):477-485 (1999), which is hereby incorporated by reference in its entirety).

Thermoplastic poly((meth)acrylated epoxidized triacyl glycerides) (PAETAG) are branched chain polymers with (meth)acrylate primary chains and AETAG-derived pendant groups. Since AETAGs have a distribution in the number of (meth)acrylate functionalities, multiply (meth)acrylated instances can be present both as branch points and sources of residual vinyl functionality in the PAETAG. Moreover, PAETAGs contain ester, oxirane and alcohol moieties throughout the macromolecule. This diversity chemical groups presents an unusually broad variety of mechanisms through which compatibilizing graft copolymers can be formed in a reactive extrusion process. For example, poly(acrylated epoxidized high oleic soybean oil) (PAEHOSO) could couple with the 1,2 vinyl pendants in a poly(butadiene) through thermally or chemically generated free radicals. At the same, time PAEHOSO can dynamically form ester bonds with polyesters or polyamides through the ring opening esterification of an oxirane group with a free acid or amine. Through these covalent bonds PAEHOSO-polybutadiene, PAEHOSO-polyamide, or even polybutadiene-PAEHOSO-polyamide graft copolymers could be produced to promote thermodynamically stable blends of the constituent components. A potentially complicating issue is the thermal stability of the PAETAG. PAETAG is unusual as a thermoplastic polymer since its monomer is multiply functional, which necessarily implies a tendency to form thermosets, i.e. infinite polymer networks. Thermoplastic PAETAG is formed when the formation of this network is suppressed through processes like controlled radical polymerization. However, the application of heat to concentrated PAETAG generates further thermally generated free radicals that quickly cure the polymer to transform it to a thermoset. Surprisingly, when melt processed with other polymers like polylactide, polyamide, polydiene, or a combination thereof macrogelation does not occur and the resultant polymer blends remain thermoplastic and melt processable.

Currently, acrylated epoxidized vegetable oils have shown promise as potentially low Tg thermoset plasticizers (Mauck et al., Macromolecules 49:1605-1615 (2016), which is hereby incorporated by reference in its entirety). These vegetable oils contain many reactive chemical moieties such as epoxy, acrylic, and alcohol functionality that can be reacted in an extruder barrel with various other diene-containing polymers or copolymers; however, plasticizers can significantly alter the Tg of hard segments like polystyrene in SBS copolymers. Therefore, the polymerization of the vegetable oils discussed in the present application is an ideal way to preserve the polystyrene glass transition temperature. With the innate ability for the acrylic functionality to undergo polymerization, acrylated vegetable oils can undergo polymerization via reversible addition fragmentation chain transfer to generate high molecular weight homopolymers, copolymers, and block copolymers which can be used to synthesize a biobased thermoplastic elastomer. A series of poly acrylated epoxidized high oleic soybean oil polymers (PAHOESO) at varying molecular weights, polymer architectures and compositions were synthesized. This strategy is an effective way to form grafts between the unsaturated double bonds left on the backbone in polydienes and the vinyl functionality on the aliphatic soybean polymer. Typically, polydienes are found as SBS triblock copolymers which are used as asphalt modifiers to enhance elasticity in the binder.

Preferences and options for a given aspect, feature, embodiment, or parameter of the technology described herein should, unless the context indicates otherwise, be regarded as having been disclosed in combination with any and all preferences and options for all other aspects, features, embodiments, and parameters of the technology.

The present technology may be further illustrated by reference to the following Examples which are presented to illustrate various aspects of the present application, but are not intended to limit the scope of the claims.

### EXAMPLES

### Materials and Methods

Epoxidized High Oleic Soybean Oil (EHOSO) was supplied by CHS, triethylamine, hydroquinone, and acrylic acid were all purchased from Sigma Aldrich with purity of 99% or higher. Carbon Disulfide, ethane thiol, p-tosyl chloride and azobisisobutyronitrile were purchased from Sigma Aldrich. Glycidyl methacrylate, 2,2-azobis 2-methylpropionitrile, and dioxane were purchased from Sigma Aldrich with purities of 98% or higher. Methanol was purchased from Fischer scientific with a purity of 99.8%. The asphalt binder with a PG grade of 64-22 was obtained from a Jebro asphalt terminal in Sioux City, Iowa. A linear SBS polymer was used as received along with elemental sulfur and poly-phosphoric acid (PPA).

### Example 1—Acrylation of Epoxidized High Oleic Soybean Oil

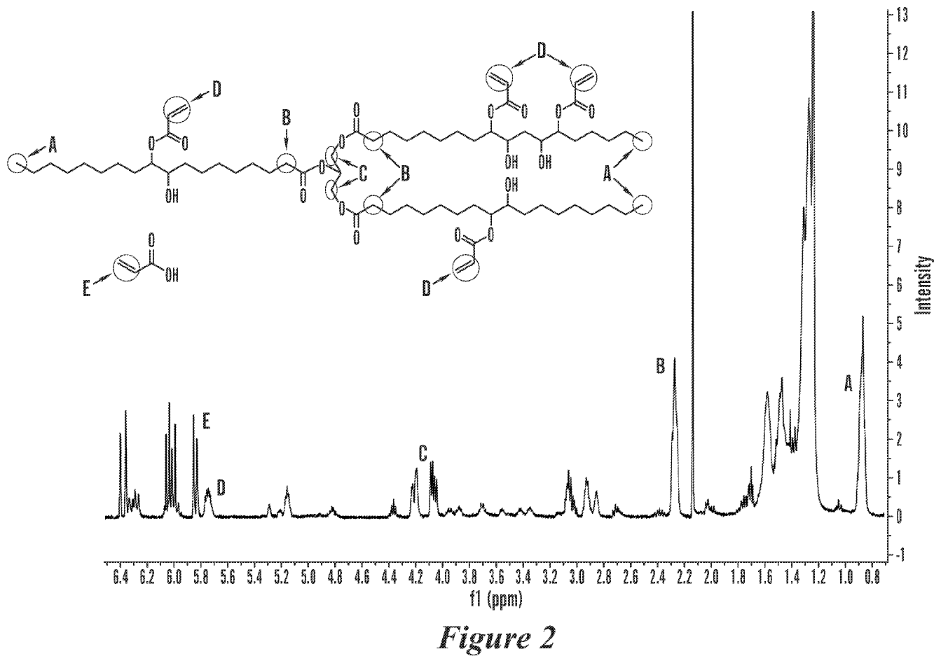

100 g of EHOSO (0.103 mol), 27.5 g of acrylic acid (0.319 mol), 0.893 g triethylamine (0.7% w/w of EHOSO), and 1.6 g hydroquinone (1.25% w/w of EHOSO) were added in a round bottom flask agitated with magnetic stirring. The flask was flushed with Argon and was allowed to react 4 hours at 110° C. with septa to achieve an acrylic functionality of 2.15. After the reaction was completed, distillation was performed at 100° C. under vacuum to remove the excess acrylic acid. ¹H-NMR (Broker, AVII, 600 MHz) in CDCl₃ was used to confirm structure and purity: δ 0.8-1.1 ppm (t, 9H, CH₃CH₂), δ 2.2-2.4 ppm (m, 6H, COCH₂CH₂), δ 4.2-4.4 ppm (m, 4H, 2×CH₂), δ 5.70-6.5 ppm (m, 3H, CH₂CH₂) as shown in FIG. 2.

### Example 2—RAFT Polymerization of Acrylated Epoxidized High Oleic Soybean Oil in Soybean Oil

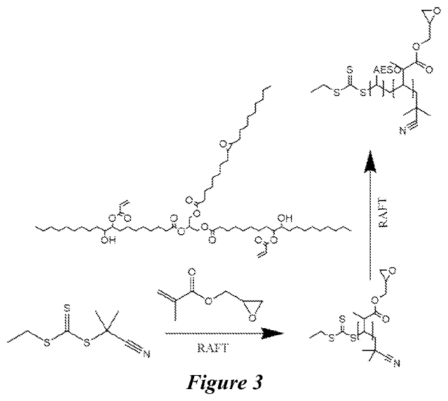

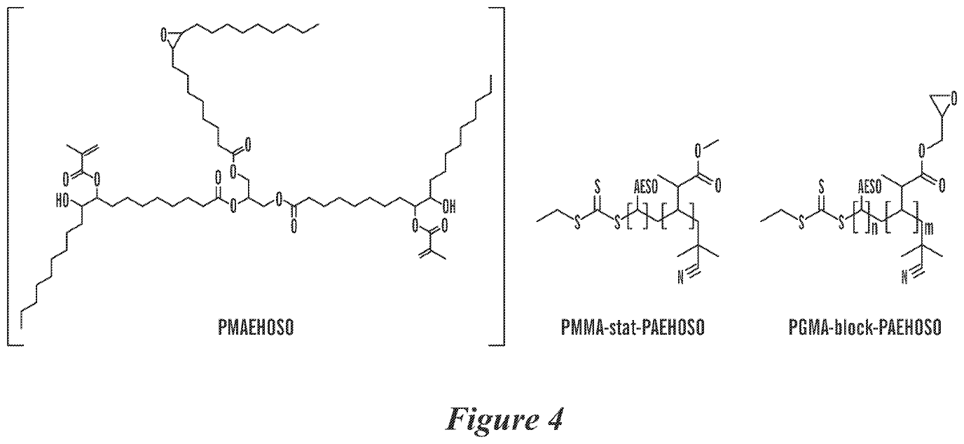

50 g of Acrylated Epoxidized High Oleic Soybean Oil (0.0454 mols), 0.1894 g of 2,2-azobis(2-methylpropionitrile) (0.00115 mols), 0.0157 g (0.000077 mols) of 2-ethyl(3-oxobutan-2-yl) carbonotrithioate (OxCART), and 51.5 g (0.0568 mols) of sub-epoxidized soybean oil (SESO) were added to a round bottom flask equipped with a stir-bar. The reaction vessel was purged for 30 minutes with argon and the reaction proceeded at 100° C. for 2 hours. The reaction was quenched with the addition of hydroquinone at 0.1% by wt of the reaction contents. The reaction scheme can be seen in FIG. 3. A small sample of the reaction was precipitated in menthol and n-hexanes for analysis with GPC and ¹H-NMR. ¹H-NMR (Broker, AVII, 600 MHz) in CDCl₃ was used to confirm structure and purity: δ 0.8-1.1 ppm (t, 9H, CH₃CH₂), δ 2.2-2.4 ppm (m, 6H, COCH₂CH₂), δ 4.2-4.4 ppm (m, 4H, 2×CH₂), δ 5.70-6.5 ppm (m, 3H, CH₂CH₂) as shown in FIG. 2. FIG. 4 shows the polymer architecture of the exemplary triglyceride based thermoplastic polymers.

### Example 3—RAFT Polymerization of Glycidyl Methacrylate (PMGA-CTA)

30 g of glycidyl methacryalate (0.2113 mols), 0.1153 g of 2,2-azobis(2-methylpropionitrile) (0.0006 mols), 0.615 g (0.0030 mols) of 2-cyanopropan-2-yl methyl carbonotrithioate (CYCART), and 31 g (0.3517 mols) of dioxane were added to a round bottom flask equipped with a stir-bar. The reaction vessel was purged for 30 minutes with argon and the reaction proceeded at 80° C. for 4 hours. The reaction was precipitated in methanol and dried at 50° C. overnight. A small sample was then taken to perform gel permeation chromatography (GPC) to determine molecular weight.

### Example 4—RAFT Polymerization of Glycidyl Methacrylate-b-Poly Acrylated Epoxidized High Oleic Soybean Oil

12 g (0.0100 mols) of acrylated epoxidized high oleic soybean oil (AHOESO), 3 g (0.062236 mols) of PGMA-RAFT CTA from Example 3, 0.05768 g (0.00119 mols) of AMBN (2,2′-azodi(2-methylbutyronitrile)), and 33.14 g (0.376 mols) of dioxane were added to a round bottom flask equipped with astir-bar. The reaction vessel was purged for 30 minutes and then the reaction proceeded at 80° C. for 2.5 hours. The reaction was then precipitated in methanol and dried. A small sample was taken for NMR to determine the composition. ¹H-NMR (Broker, AVII, 600 MHz) in CDCl₃ was used to confirm the structure and composition.

### Example 5—Preparation of Polymer Blends

The fabrication of the A+B or A+B+AB polymer blends was performed by extruding a calculated amount of polymer modifier with various amounts of PLA depending on the composition. The polymer was then melt blended using a Haake miniLab twin screw extruder. The extrudate was cooled and prepared for injection molding. The blends were synthesized at 220° C. with a 10-minute residence time.

### Exemplary Synthesis of BABS-A

The BABS-A blend consists of poly acrylated epoxidized high oleic soybean oil (PAEHOSO) polymerized in its sub epoxidized soybean oil (SESO) solvent at a 1:1 mass ratio with a target molecular weight of 500 kDa. The PAEHOSO and SESO reactor product is then physically mixed together at a loading of 10 wt % with PLA at room temperature. The physically mixed product is then put into the Haake compounder at 5 g per cycle at 220° C. After 10 minutes the extrudate was extruded from the compounder to yield the BABS-A blended product.

The BABS series was thought to be a possible impact modifier for PLA as the polymer mixture contains a Tg of −40° C. and has epoxide functionality that can chain extend with the carboxylic acid end groups of PLA to stabilize the interface between the soybean elastomer and PLA. The results showed an increase in elongation at break; however, switching to a methacrylic backbone was thought to increase the mechanical performance since polymethyl methacrylate (PMMA) is known to be miscible with PLA. An increase in the interfacial adhesion using a methacrylic backbone would yield smaller micelles increasing mechanical performance.

### Exemplary Synthesis of BABSMA-A

The BABSMA-A blend consists of poly methacrylated epoxidized high oleic soybean oil (PMAEHOSO) polymerized in its sub epoxidized soybean oil solvent at a 1:1 mass ratio with a target molecular weight of 500 kda. The PMAEHOSO and SESO reactor product is then physically mixed together at a loading of 10 wt % with PLA at room temperature. The physically mixed product was then put into the Haake compounder at 5 g per cycle at 220° C. After 10 minutes the extrudate was extruded from the compounder to yield the BABSMA-A blended product.

The BABSMA series was thought to be a possible impact modifier for PLA as the polymer mixture contains a Tg of −46° C. and has epoxide functionality that can chain extend with the carboxylic acid end groups of PLA to stabilize the interface between the soybean elastomer and PLA. A further increase in the elongation was seen by switching to a methacrylic backbone; however, it was decided that synthesizing statistical copolymers of PMMA with PAHOESO would increase the interfacial adhesion between the dispersed phase and the PLA matrix.

### Exemplary Synthesis of BABSCO-B

The BABSCO-B blend consists of PMMA copolymerized with PAEHOSO with a target MW of 500 kDa. 50 g (0.0418 moles) of AEHOSO, 22 g of MMA (0.2195 moles), 0.0138 g of AMBN (7.2E-5 moles), 0.02951 g of CyCART (1.44E-4 moles), and finally 70 g of SESO were added to a 3-neck round bottom flask equipped with a mechanical agitator. The reactor flask was then purged with argon for 30 minutes before being reacted at 100° C. The reaction then proceeded for 1.5 hours before the reaction was quenched with inhibitor. H-NMR (Broker, AVII, 600 MHz) in CDCl₃ was used to confirm the structure and composition of ˜30 wt % PMMA. The reactor product was then physically mixed together at a loading of 20 wt % with PLA at room temperature. The physically mixed product was then put into the Haake compounder at 5 g per cycle at 220° C. After 10 minutes the extrudate was extruded from the compounder to yield the BABSCO-B blended product.

The elongation showed an increase by 2 orders of magnitude; however, the impact strength was still found to not increase. In order to increase the impact strength, it was thought that a highly entangled rubber would be required. Ethylene-co-methyl acrylate-co-glycidyl methacrylate (EMA-GMA) was selected as a potential candidate to increase the impact strength

### Exemplary Synthesis of BABSELVA-F

BABSELVA is a ternary blend of 10 wt % PAEHOSO with SESO and 10 wt % EMA-GMA. The materials were physically mixed together prior to extruding in the Haake extruder. The physically mixed product was then put into the Haake compounder at 5 g per cycle at 220° C. After 10 minutes the extrudate was extruded from the compounder to yield the BABSELVA-F blended product.

The impact strength was shown to increase by an order of magnitude confirming

that an entangled rubber would be necessary to receive increases in impact strength. While the impact strength increased, the compostability aspect of the blend was removed. In order to combat this pure polymer was synthesized with the thought that removal of the plasticizer would help combat the decrease in impact strength observed.

### Exemplary Synthesis of PAHMA-A

PAHMA-A was synthesized with a target MW of 500 kDa. 50 g of Methacrylated Epoxidized High Oleic Soybean Oil (0.0454 mols), 0.1894 g of 2,2-azobis(2-methylpropionitrile) (0.00115 mols), 0.0157 g (0.000077 mols) of 2-cyanopropan-2-yl methyl carbonotrithioate (CyCART), and 51.5 g of dioxane were added to a round bottom flask equipped with a stir-bar. The reaction vessel was purged for 30 minutes with argon and the reaction proceeded at 80° C. for 2 hours. The reaction was quenched with the addition of hydroquinone at 0.1% by wt of the reaction contents. The reaction contents were precipitated in methanol and then dried in the vacuum ovens for 4 hours. This product is referred to as PMAEHOSO in FIG. 4. The dried product was then mixed with PLA at 10 wt % and put into the Haake extruder.

The material properties showed the removal of SESO had a large effect on the tensile toughness attributing to 2 orders of magnitude increase from the BABSMA-A blend; however, the impact strength was relatively unaffected.

### Exemplary Synthesis of PAHCO-A

The PAHCO-A blend consists of PMMA copolymerized with PAEHOSO with a target MW of 500 kDa. 50 g (0.0418 moles) of AEHOSO, 22 g of MMA (0.2195 moles), 0.0138 g of AMBN (7.2E-5 moles), 0.02951 g of CyCART (1.44E-4 moles), and finally 70 g of dioxane. This polymer is referred to as PMMA-stat-PAEHOSO in FIG. 4. The contents were poured into a round bottom flask equipped with a magnetic stir-bar. The reaction was purged for 30 minutes using argon. The reaction was then heated to 80° C. for 2 hours. The reaction was quenched with the addition of hydroquinone at 0.1% by wt of the reaction contents. The reaction contents were precipitated in methanol and then dried in the vacuum ovens for 4 hours. The dried product was then mixed with PLA at 10 wt % and put into the Haake extruder. The material properties showed similar mechanical properties with the BABSCO-B blend; however, the impact strength was relatively unaffected.

### Exemplary Synthesis of PAHBLO-L

30 g of glycidyl methacryalate (0.2113 mols), 0.1153 g of 2,2-azobis(2-methylpropionitrile) (0.0006 mols), 0.615 g (0.0030 mols) of 2-cyanopropan-2-yl methyl carbonotrithioate (CYCART), and 31 g (0.3517 mols) of dioxane were added to a round bottom flask equipped with a stir-bar. The reaction vessel was purged for 30 minutes with argon and the reaction proceeded at 80° C. for 4 hours. The reaction was precipitated in methanol and dried at 50° C. overnight yielding PGMA-RAFT-CTA. A small sample was then taken to perform gel permeation chromatography (GPC) to determine molecular weight. The molecular weight was determined to be ˜8 kDa using PMMA standards. 12 g (0.0100 mols) of acrylated epoxidized high oleic soybean oil (AEHOSO), 3 g (0.062236 mols) of PGMA-RAFT CTA from Example 3, 0.05768 g (0.00119 mols) of AMBN (2,2′-azodi(2-methylbutyronitrile)), and 33.14 g (0.376 mols) of dioxane were added to a round bottom flask equipped with a stir-bar. The reaction vessel was purged for 30 minutes and then the reaction proceeded at 80° C. for 2.5 hours. The reaction was then precipitated in methanol and dried. A small sample was taken for NMR to determine the composition. ¹H-NMR (Bruker, AVII, 600 MHz) in CDCl₃ was used to confirm the structure and composition. The product yielded a block copolymer with an Mn of ˜20 kDa with a block composition of ˜10 wt % PGMA. This product is referred to as PGMA-block-PAEHOSO in FIG. 4. The block copolymer was then blended with PLA at 10 wt % in the Hakke extruder using a cycle time of 10 minutes at 220° C.

The polymer blend yielded excellent mechanical properties showing both an order of magnitude increase in tensile toughness and impact strength. This is likely due to the ability of the PGMA block to form a corona around the PAEHOSO core allowing for the synthesis of a core-shell micelle.

### Exemplary Synthesis of PAHTERN

PAHTERN is a ternary blend using PGMA-block-PAEHOSO at 10 wt %, polybutylene succinate (PBS) at 20 wt %, and PLA at 70 wt %. The mixture was extruded using the Hakke extruder with a cycle time of 10 minutes at 190° C. The polymer blend yielded a blend that showed an order of magnitude increase in impact strength showing that PGMA-block-PAEHOSO could be used to compatibilize PBS with PLA. PBS is known to be readily compostable while PLA is industrially compostable with the goal that a small amount of PBS chain extended with PLA would yield an engineering thermoplastic that is durable and readily compostable.

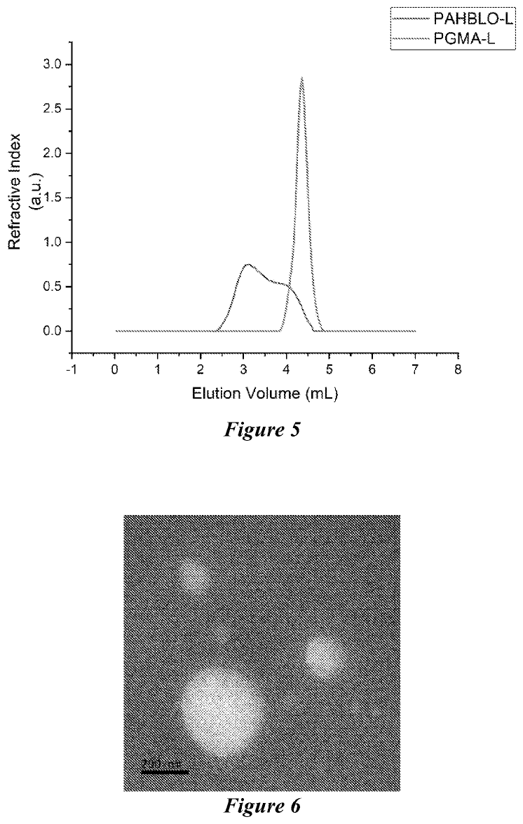

Formulations of the differ polymer blends are shown in Table 1. The GPC of exemplary polymer PAHBLO-A is shown in FIG. 5.

TABLE 1
Differing compositions of Ingeo Poly lactic acid (PLA),
differing (Meth)Acrylate Polymers with homopolymers
or copolymers of PAHOESO, SESO as a plasticizer, Ethylene
based copolymers (ethylene-methyl acrylate-glycidyl
methacrylate copolymer (EMA-GMA)), and PBS.

| Sample | PLA | Biopolymer | SESO | EMA-GMA | PBS |
|---|---|---|---|---|---|
| Code | wt % | wt % | wt % | wt % | wt % |
| PLA | 100.0 | 0.0 | 0.0 | 0.0 | 0.0 |
| BABS-A | 90.0 | 5.0 | 5.0 | 0.0 | 0.0 |
| BABS-B | 80.0 | 10.0 | 1.0 | 0.0 | 0.0 |
| BABS-C | 70.0 | 15.0 | 15.0 | 0.0 | 0.0 |
| BABSMA-A | 90.0 | 5.0 | 5.0 | 0.0 | 0.0 |
| BABSMA-B | 80.0 | 10.0 | 10.0 | 0.0 | 0.0 |
| BABSMA-C | 70.0 | 15.0 | 15.0 | 0.0 | 0.0 |
| BABSCO-B | 85.0 | 10.0 | 5.0 | 0.0 | 0.0 |
| BABSELVA-F | 80.0 | 5.0 | 5.0 | 10.0 | 0.0 |
| PAHTERN | 70.0 | 10.0 | 0.0 | 0.0 | 20.0 |
| PAHMA-A | 90.0 | 10.0 | 0.0 | 0.0 | 0.0 |
| PAHCO-A | 90.0 | 10.0 | 0.0 | 0.0 | 0.0 |
| PAHBLO-L | 90.0 | 10.0 | 0.0 | 0.0 | 0.0 |
| PAHBLO-H | 90.0 | 10.0 | 0.0 | 0.0 | 0.0 |

Sample code and biopolymers: The biopolymer for BABS and BABSELVA samples is 500 kDa PAEHOSO; the biopolymer for BABSMA and PAHMA is 500 kDa PMAEHOSO; the biopolymer for BABSCO and PAHCO biopolymer is 500 kDa PMMA/PAEHOSO; the biopolymer for PAHBLO and PAHTERN is PGMA-PAEHOSO.

Blends with SBS block copolymer and sulfur were prepared using similar methods to those of the PLA polymers, with a temperature of 170° C. and a residence time of 6 minutes (see Table 2 for SBS formulations (BioMAG)).

TABLE 2
BioMAG pellet composition

| | SBS | PAEHOSO | SESO | Sulfur | PPA |
|---|---|---|---|---|---|
| Sample Code | wt % | wt % | wt | wt % | wt % |
| BioMAG - A | 22.58 | 29.36 | 47.43 | 0.0045 | 0.0017 |
| BioMAG - B | 33.13 | 33.13 | 33.13 | 0.0060 | 0.0000 |
| BioMAG - C | 33.13 | 33.13 | 33.13 | 0.0066 | 0.0000 |

### Example 6—Asphalt Blending

Blends were prepared by heating the 64-22 asphalt binder to 140.0° C. and mixing at 150 RPM for 10.0 minutes using a IKA mixer. A polymer of the desired weight was added to the binder over the course of 10.0 minutes. The polymer was allowed to blend for an additional 15 hrs. The sample was then removed and allowed to cool. The RPM chosen was selected to eliminate any oxidative effects. The formulations of the asphalt blends are shown in Table 3.

TABLE 3
Formulations of Asphalt Blends

| | Asphalt Binder | BioMAG Pellet | SESO |
|---|---|---|---|
| Sample Code | wt % | wt % | wt % |
| 6422 | 100.00 | 0.0 | 0.0 |
| 6422 - S | 95.50 | 0.0 | 4.5 |
| 6422 - BIOMAG - A | 91.60 | 8.4 | 0.0 |
| 6422 - BIOMAG - B | 91.20 | 6.7 | 2.5 |
| 6422 - BIOMAG - C | 93.80 | 6.2 | 0.0 |

### Example 7—Preparation of Mechanical Property Test Samples

The extrudate was used to make ASTM D256 IZOD bars and ASTM D638 Type 5 dogbones. A Haake MiniJet injection molder was used with the barrel temperature set to 240° C. and a mold temperature of 40° C. The Ram pressure was set to 700 bar. Notches were then created under the ASTM D256 Specifications. ASTM D256 specifications can be described as having dimensions of 63.5×12.5×3.2. The dimensions are all in millimeters where the length, width, and thickness of the IZOD bar correspond to the values above.

### Example 8—Asphalt Binder Rheology Testing

This experiment used 5 common rheology based parameters: (1) the complex modulus (G*), (2) percent recovery (3.2 kPa), (3) non-recoverable creep compliance (Jnr 3.2), (4) creep stiffness (S), and (5) relaxation (m-value) to determine the property change of rejuvenated asphalt binders. The complex modulus was obtained from a dynamic shear rheology test using AASHTO T315. The percent recovery and non-recoverable creep compliance were obtained using AASHTO T350. The creep stiffness and m-value were obtained using ASSHTO T313. The Dynamic Shear Rheology (DSR) was performed on the Anton parr Smart Pave 92 according to AASHTO M332 standard. For these experiments, the VTB binder was tested at 58° C. and 64° C. using the AASHTO T315 and AASHTO T350 Standards. The Bending Beam Rheometer (BBR) test method was performed on a ATS Bending Beam Rheometer (BBR2S) to measure the creep stiffness and relaxation at −6° C., −12° C., and −18° C. according to AASHTO T 313-12.

### Example 9—Mechanical Property Tests

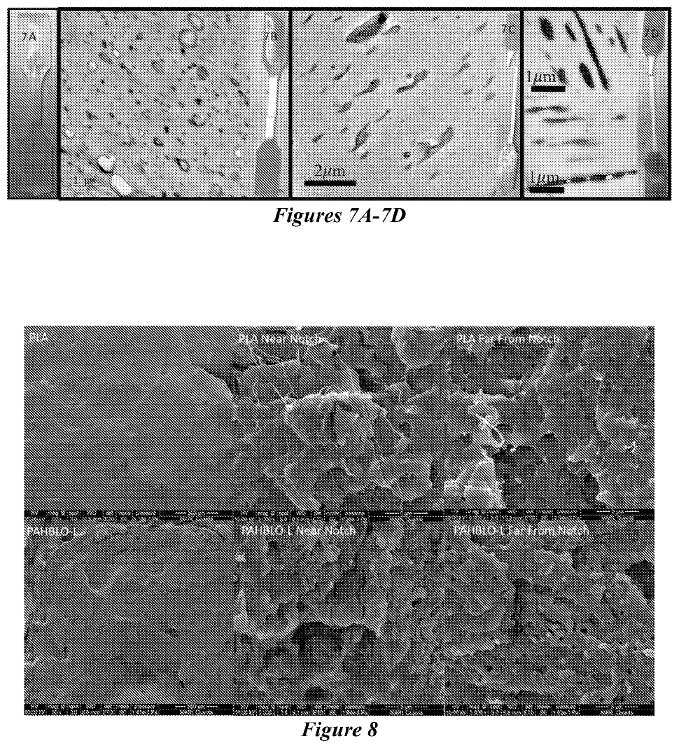

Uniaxial tensile tests were performed with an Instron 3367 tensile testing machine using a cross-head moving rate of 5 mm/min. Images of the samples after tensile tests are shown in FIGS. 7A-7D. FIG. 8 shows the SEM of the fracture surfaces of PAHBLO-L blends in comparison to the PLA homopolymer. Impact Tests were conducted using a Tinius Olsen 527 at room temperature according to ASTM D256 (Notched Izod Impact). The specimen is clamped into the test fixture with the notched side facing the striking edge of the pendulum. The pendulum is released and allowed to strike through the specimen, and the impact energy is reported by the instrument. The value reported was represented as an average over 5 specimens. The elastic modulus was calculated using the points below 1% elongation. The modulus of toughness was calculated as the area under the stress strain curves. The tensile properties were performed under amorphous conditions, while the impact strength was performed under annealed conditions. A summary of the results of the mechanical testing is shown in Table 4, the stress is identified as σ, strain is ε, stiffness is E, U_{I} is impact strength, and tensile toughness is U_{T}.

TABLE 4
Summary of Mechanical properties of differing polymer blends

| | σ | E | ε_{b} | U_{T} | U_{I} |
|---|---|---|---|---|---|
| Sample Code | (MPa) | (MPa) | (%) | (MJ/m³) | (J/m) |
| PLA | 67 ± 2 | 2512 ± 112 | 3 ± 1 | 1 ± 1 | 76 ± 11 |
| BABS-A | 48 ± 2 | 2291 ± 144 | 14 ± 2 | 5 ± 1 | 52 ± 2 |
| BABS-B | 44 ± 2 | 2266 ± 291 | 14 ± 1 | 3 ± 1 | 48 ± 1 |
| BABS-C | 36 ± 2 | 2096 ± 290 | 11 ± 1 | 2 ± 1 | 24 ± 1 |
| BABSMA-A | 48 ± 2 | 2131 ± 300 | 20 ± 7 | 6 ± 2 | 63 ± 3 |
| BABSMA-B | 43 ± 2 | 1812 ± 492 | 30 ± 5 | 8 ± 1 | 46 ± 1 |
| BABSMA-C | 35 ± 2 | 1814 ± 51 | 27 ± 1 | 6 ± 1 | 28 ± 1 |
| BABSCO-B | 52 ± 2 | 1958 ± 88 | 141 ± 14 | 55 ± 1 | |
| BABSELVA-F | | | | | 251 ± 26 |
| PAHTERN | | | | | 228 ± 21 |
| PAHMA-A | 51 ± 2 | 2025 ± 312 | 135 ± 12 | 54 ± 1 | |
| PAHCO-A | 51 ± 1 | 1938 ± 248 | 150 ± 10 | 59 ± 1 | |
| PAHBLO-L | 66 ± 1 | 1984 ± 247 | 112 ± 5 | 47 ± 1 | 228 ± 41 |
| PAHBLO-H | 65 ± 1 | 2180 ± 55 | 44 ± 1 | 18 ± 1 | 122 ± 10 |

### Example 10—Analysis of Microstructure

Analysis of polymers microstructure was performed on a 200 kV JEOL 2100 Scanning/Transmission Electron Microscope. Each TEM specimen was ultra-microtomed at −70° C. in the whitened gauge region of the tensile bar, shown in FIG. 6.

### Results and Discussion of Examples 1-10

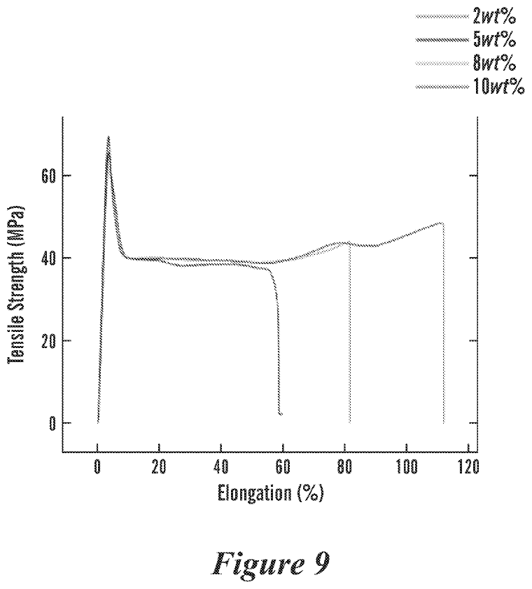

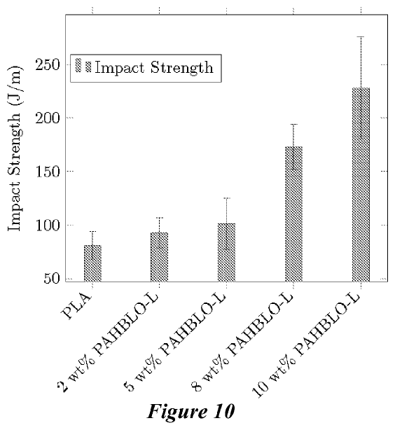

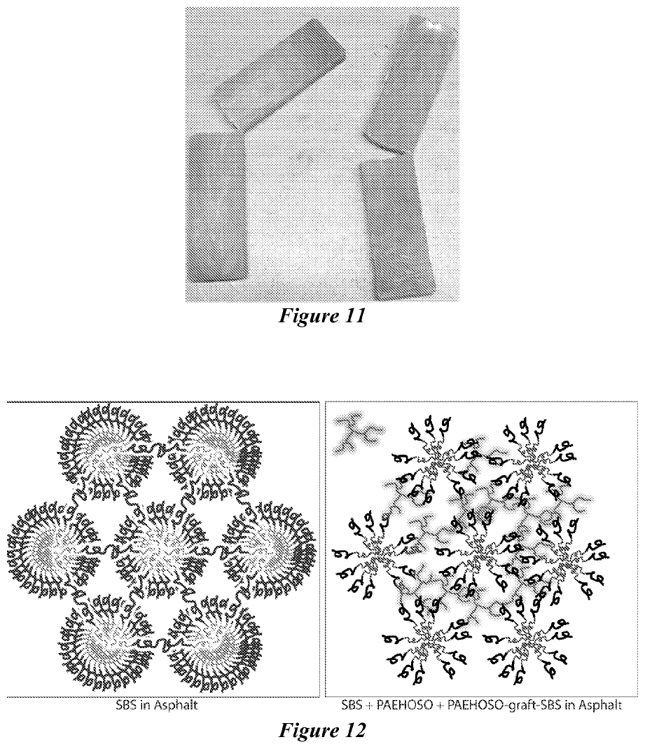

The PLA blends were all prepared via reactive extrusion. The reactive extrusion process between PLA, the various PA-HOESO polymer architectures, and SESO utilizes the epoxy rings and the carboxylic acid chemical moieties. The resultant blends would then branch and form graft copolymers inducing compatibility between the PLA phase and the oil phases. TEMs showing a compatibilized blend can be seen in FIGS. 7A-7D. Micelle sizes range from 100-500 nanometers. The micelle morphology is influenced by the polymer architecture and the miscibility of each polymer with the matrix. BABS-C showed 500-1 um spherical domain sizes, PAHCO-A showed roughly 400 nm teardrop micelles, and PAHBLO-L showed 400 nm-1 um rod-like micelles with roughly a diameter of 80-150 nm. The phase behavior is quite surprising as typically spherical micelles are the preferred choice due the balance of interfacial energy around the structure; however, Li et al., ACS Macro Letters 5:359-364 (2016), which is hereby incorporated by reference in its entirety, noted that cylindrical micelles showed the largest improvement in toughening efficiency. While the micelles shown in the PEO-b-PBO are around 100 nm, the micelles displayed in the PAHOESO elastomer system are much larger; uniquely, in the PAHBLO-L system, the micelles are much larger showing sizes around 1-4 um post deformation with even higher mechanical performance than PEO-b-PBO. This could be attributed to the propagation of cavitation shown in FIG. 8. This unique behavior could explain why the mechanical performance is shown to be exemplary while having macromolecular structure. Mechanical performance was determined by Instron Universal Testing and IZOD Impact Testing. Tensile test samples were injection molded as amorphous specimens and tested. FIG. 9 indicated that a loading of 2% PAHBLO-L showed no improvement, likely due to the lack of the phase separation of the block copolymer in the blend. However, upon the addition of 5 wt % of PAHBLO-L, a dramatic increase in elongation and an order of magnitude increase in Modulus of Toughness was achieved. Similarly, FIG. 10 indicates the values for impact strength with a 10 wt % loading shows an impact strength equal to that of ABS, approximately 230 (J/m). FIG. 11 also shows hinge breaks rather than complete breaks attributing to the increased toughness provided by the PAHBLO-L polymer. Summaries of mechanical performance can be seen in Table 4 where all polymer blends displayed different levels of toughening efficiency. Blends with SESO and without SESO show a drastic reduction in both the strength and the elongation. This is likely due to the swelling of the plasticization effect and swelling of the polymer micelles in the blends. All polymer blends showed no dramatic loss in elastic modulus. However, as the SESO loading increased, the tensile strength dropped by 30%-50%. In terms of mechanical performance, the block copolymer has the greatest performance since it likely organizes into core-shell micelles allowing for cavitation of the dispersed phase. With the PGMA block being both miscible and reactive with the matrix, this leads to primarily a core-shell structure with PGMA chains being sequestered with the matrix and PAHOESO domains being phase-separated, acting as the core. Cavitation of the micelle can be seen in FIG. 8, where white holes are present in the micelle. Cavitation leads to rapid energy dissipation due to the volume increase from the small infinitesimal defect growing into a nanometer-sized cavity.

Like the PLA blends the BioMAG blends were all prepared via reactive extrusion. The reactive extrusion of SBS polymers with PAEHOSO and SESO materials used the epoxy and vinyl groups for developing highly branched polymer networks. The well entangled and vinyl rich SBS polymer provides PAEHOSO with the perfect polymer for graft sites. Grafting the SBS and PAEHOSO polymers together greatly extends the elastomeric network resulting in higher performance in applications such as asphalt pavements where high resistance to wear is desired. The addition of a soy based rejuvenation agent like SESO into the BioMAG blends provides a softened pellet that readily dissolves in asphalt. It is important to note that typical polymer SB/SBS polymer modification use temperatures between 180-150° C. and high shear apparatuses to fully incorporate polymers. The BioMAG polymer pellet was successfully blended into asphalt at reduced temperatures of 120-150° C. and in the absence of high shear blending. Table 5 shows the preliminary results of a pelletized BioMAG pellet in asphalt binder. As can be seen the composition of BioMAG pellet has a drastic influence on performance. The lack of rejuvenation from the soy based rejuvenator (SESO) is likely attributed to the vulcanization of the residual alkene groups on the triglyceride molecule with SBS or PAEHOSO. Anchoring the SESO molecules to the polymer backbone severely limits how SESO molecules interact with asphaltene molecules. The free flowing nature of SESO molecules is paramount to fully interact with asphaltenes and revitalize asphalt binders. This can be seen in how blends BioMAG-A & B both possess the same SESO amount, but BioMAG-B demonstrated a lower performance grade with half of the SESO being added separately. This theory is supplemented by the change in ΔTc between the BioMAG-A & B blends. The rheology testing results are shown in Table 5. These results help to understand the role of each additive in the BioMAG pellet and the subsequent mechanical property outcome. The results in Table 5 demonstrate that poly-phosphoric acid, when reacted in the pellet, has a minimal negative affect on the performance grade and elasticity. The large increase in the ΔTc is likely due to the high polymer loading and absence of SESO. This is contradictory to what has been previously seen in the presence of SESO.

TABLE 5
Rheology testing of the BioMAG pellet and various
formulations blended into 64-22 asphalt binders.

| | Performance | MSCR | | Mass |
|---|---|---|---|---|
| Sample Code | Grade | 64.0° C. | ΔTc | Loss |
| 6422 | (65.4-25.1) | — | −0.6 | — |
| 6422 - S | (58.9-29.7) | — | 0.0 | — |
| 6422 - BIOMAG - A | (77 7-25.3) | 23.21% | −5.7 | 0.25% |
| 6422 - BIOMAG - B | (74.0-27.0) | 15.43% | −3.1 | 0.17% |
| 6422 - BIOMAG - C | (76.9-23.4) | 21.82% | −5.3 | 0.12% |

A series of reactive PAHOESO polymer architectures were uniformly dispersed as differing morphology micelles resulting in compatibilized A+B+AB polymer blends. The mechanical properties showed an order of magnitude increase in tensile toughness and notched izod impact strength over neat PLA. The micelles toughen the PLA matrix by inducing cavitation, crazing, and shear yielding throughout the thermoplastic matrix while undergoing deformation depending on the polymer architecture. These results show that a biobased polyester can be toughened with a biobased polymer at low loadings while maintaining the thermal and mechanical properties of the original matrix.

The A+B+AB polymer blends can be formed inside the extruder barrel. These AB-type polymers could be used as a dispersed phase to chain extend with the matrix yielding graft copolymers in the extruder barrel. Originally, the BABS series blends were thought to be able to be used as a high-performance impact modifier; however, only the elongations of the polymer blends could be improved. Since it is well known that PMMA is miscible with PLA, exchanging out the acrylic AEHOSO backbone (BABS) with a methacrylic backbone (BABSMA) was thought to provide an increase in the interfacial adhesion between the soybean rubber phase and the PLA rigid phase. While improvements in the tensile properties can be seen, the impact strength was once again a concern. Copolymers of the BABSCO blends display the addition of ˜30 wt % PMMA statistically polymerized into the AEHOSO backbone can increase the elongation at break 2 orders of magnitude higher than the BABSMA series. This is because PMMA is miscible with PLA enhancing the adhesion between the soybean copolymer rubber and the PLA matrix. The impact strength was still unaffected, likely due to the lack of the rubber containing entanglements that provide elasticity. With this concept in mind, BABSELVA blends were synthesized. EMA-GMA is an ethylene-based highly entangled rubber that when extruded with PLA can enhance the impact strength. This blend showed an order of magnitude increase in impact strength; however, the compostability aspect of the blend was effectively eliminated. Since the compostability aspect of the blend was the ultimate goal, the removal of SESO from the soybean-based polymer was thought to help increase the impact strength since plasticizers cannot undergo common deformation mechanisms. PAHCO and PAHMA blends, which contain no SESO, showed similar results to BABSCO blends where large increases in tensile properties were observed without increases in impact strength. Ultimately, a block copolymer was formulated with the thought that a reactive amphiphilic block copolymer would allow for the synthesis of a core-shell micelle with a PGMA corona and a PAEHOSO core. PAHBLO-L showed both an order of magnitude increase in tensile toughness and impact strength. Finally, PAHTERN was synthesized with the goal of a durable thermoplastic blend that was also readily compostable. PLA is known to be industrially compostable while PBS is “backyard” compostable. A blend with a small percentage of PBS with PGMA-block-PAEHOSO as the compatibilizer could be used to give a blend that is both extremely durable and readily compostable.

Along with the improvement to thermoplastics, thermoplastic elastomers are also improved with the incorporation of the PAHOESO polymer with improvement in elastic performance due to the enhancement and solubility of the polymer network in asphalt. As seen in FIG. 12, the SBS+PAEHOSO+PAEHOSO-graft-SBS modified asphalt produce enhanced elasticity provided through the grafted PAEHOSO molecules that establish intermicellar connectivity. To achieve a non-agglomerated dispersion of SBS in asphalt, specialized high shear milling equipment and high temperatures near 180° C. are required. Further, the dispersed SBS must be allowed time to undergo vulcanization reactions to fully develop the elastic properties. In contrast, the compounded SBS+PAEHOSO+PAEHOSO-graft-SBS mixture dissolves in the asphalt under quiescent to mildly agitated conditions and typical asphalt production temperatures from about 120° C. to about 160° C. Moreover, SBS/PAEHOSO reactivity in the extrusion process precludes the need for allowing vulcanization reactions to occur in the asphalt before it is used. Thus the compounded SBS+PAEHOSO+PAEHOSO-graft-SBS mixture dramatically simplifies the asphalt polymer modification process such that contractors and asphalt terminal suppliers alike can formulate these materials without specialized capital equipment.

Although preferred embodiments have been depicted and described in detail herein, it will be apparent to those skilled in the relevant art that various modifications, additions, substitutions, and the like can be made without departing from the spirit of the application and these are therefore considered to be within the scope of the application as defined in the claims which follow.

What is claimed:

1. A thermoplastic graft copolymer comprising:
one or more thermoplastic polymers of formula I: 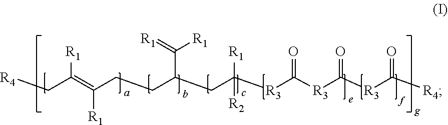
and
a branched chain thermoplastic polymer of formula II: 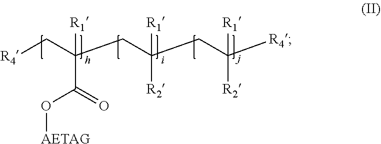
where
R¹ and R¹′ are independently selected at each occurrence thereof from the group consisting of H and methyl;
R² and R²′ are independently selected at each occurrence thereof from the group consisting of H, OH, halogen, —COOR⁵, —C(O)NR⁵R⁶, C₁-C₂₃ alkyl, and benzyl, where the C₁-C₂₃ alkyl can be optionally substituted with an aryl, heteroaryl, or heterocyclyl;
R³ is independently selected at each occurrence thereof from the group consisting of —X—R⁷—X—, C₁-C₂₃ alkylene, arylene, and heteroarylene;
R⁴ and R⁴′ are independently selected at each occurrence thereof from the group consisting of C₁-C₂₃ alkyl and benzyl, where the C₁-C₂₃ alkyl can be optionally substituted with an aryl, heteroaryl, heterocyclyl, carboxylic acid, oxirane, ester, thioester, or carbonotrithioate;
R⁵ and R⁶ are independently selected at each occurrence thereof from the group consisting of H and C₁₋₁₀ alkyl, hydoxyalkyl, or alkyloxirane;
R⁷ is independently selected at each occurrence thereof from the group consisting of 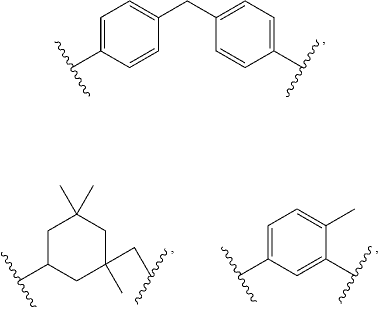
C₁₋₂₃ alkyl, where the C₁-C₂₃ alkyl can be optionally substituted with an aryl, heteroaryl, or heterocyclyl;
X is independently selected at each occurrence thereof from the group consisting of methylene, —NH—, or —O—.
AETAG is a (meth)acrylated epoxidized triacyl glyceride;
a, b, c, d, e, and f represent number average degrees of polymerization for repeat units of formula I that are distributed throughout the polymer chain in a statistically defined manner;
a, b, c, d, e, and f range from 0 to 100,000, where a+b+c+d+e+f ranges from 100 to 200,000;
g ranges from 1 to 5;
h, i, and j represent number average degrees of polymerization for repeat units of formula II that are distributed throughout the polymer chain in a statistically defined manner;
h ranges from 100 to 100,000; and
i and j range from 0 to 100,000, where the thermoplastic polymer of formula I is grafted to the thermoplastic polymer of formula II.

2. The thermoplastic graft copolymer of claim 1, wherein the thermoplastic polymer of formula (I) is a copolymer or terpolymer.

3. The thermoplastic graft copolymer of claim 2, wherein the polymer of formula I is selected from the group consisting of styrene-butadiene-styrene, styrene-isoprene, ethylene-vinyl acetate polymers, and combinations thereof.

4. The thermoplastic graft copolymer of claim 1, wherein the thermoplastic polymer of formula (I) is selected from the group consisting of polybutadienes, polyisoprenes, polystyrenes, polyacrylates, acrylamides, vinyl polymers, polyamides, and combinations thereof.

5. The thermoplastic graft copolymer of claim 4, wherein the thermoplastic polymer of formula (I) is a polymer selected from the group consisting of polyamide-6,6, polyamide-6,12, polyamide-6, polypropylene, polyvinyl chloride, poly methyl methacrylate, and polytetrafluoroethylene.

6. The thermoplastic graft copolymer of claim 1, wherein the triacyl glyceride of the (meth)acrylated epoxidized triacyl glyceride of the branched chain thermoplastic polymer of formula II is selected from the group consisting of the triacyl glycerides of soybean oil, peanut oil, walnut oil, palm oil, palm kernel oil, sesame oil, sunflower oil, safflower oil, rapeseed oil, linseed oil, flax seed oil, colza oil, coconut oil, corn oil, cottonseed oil, olive oil, castor oil, false flax oil, hemp oil, mustard oil, radish oil, ramtil oil, rice bran oil, salicornia oil, tigernut oil, tung oil, and combinations thereof.

7. The thermoplastic graft copolymer of claim 1, wherein the thermoplastic polymer of formula II has a number average molecular weight ranging from 10 kDa to 10000 kDa.

8. The thermoplastic graft copolymer of claim 1, wherein the thermoplastic polymer of formula II has at least one occurrence of R⁴′ selected from the group consisting of a thioester and carbonotrithioate.

9. A thermoplastic polymeric mixture comprising:
one or more thermoplastic polymers of formula I: 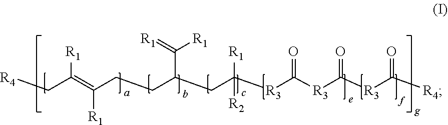
a branched chain thermoplastic polymer of formula II: 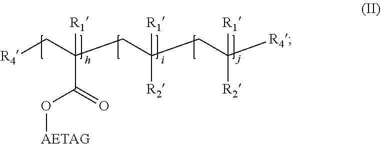
and
the graft copolymer of the present application;
where
R¹ and R¹′ are independently selected at each occurrence thereof from the group consisting of H and methyl;
R² and R²′ are independently selected at each occurrence thereof from the group consisting of H, OH, halogen, —COOR⁵, —C(O)NR⁵R⁶, C₁-C₂₃ alkyl, and benzyl, where the C₁-C₂₃ alkyl can be optionally substituted with an aryl, heteroaryl, or heterocyclyl;
R³ is independently selected at each occurrence thereof from the group consisting of —X—R⁷—X—, C₁-C₂₃ alkylene, arylene, and heteroarylene;
R⁴ and R⁴′ are independently selected at each occurrence thereof from the group consisting of C₁-C₂₃ alkyl and benzyl, where the C₁-C₂₃ alkyl can be optionally substituted with an aryl, heteroaryl, heterocyclyl, carboxylic acid, oxirane, ester, thioester, or carbonotrithioate;
R⁵ and R⁶ are independently selected at each occurrence thereof from the group consisting of H and C₁₋₁₀ alkyl, hydoxyalkyl, or alkyloxirane;
R⁷ is independently selected at each occurrence thereof from the group consisting of 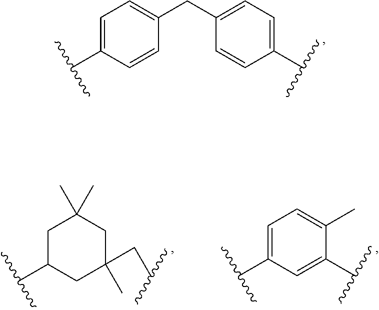
C₁₋₂₃ alkyl, where the C₁-C₂₃ alkyl can be optionally substituted with an aryl, heteroaryl, or heterocyclyl;
X is independently selected at each occurrence thereof from the group consisting of methylene, —NH—, or —O—.
AETAG is a (meth)acrylated epoxidized triacyl glyceride;
a, b, c, d, e, and f represent number average degrees of polymerization for repeat units of formula I that are distributed throughout the polymer chain in a statistically defined manner;
a, b, c, d, e, and f range from 0 to 100,000, where a+b+c+d+e+f ranges from 100 to 200,000;
g ranges from 1 to 5;
h, i, and j represent number average degrees of polymerization for repeat units of formula II that are distributed throughout the polymer chain in a statistically defined manner;
h ranges from 100 to 100,000; and
i and j range from 0 to 100,000, where the thermoplastic polymer of formula I is grafted to the thermoplastic polymer of formula II.

10. The thermoplastic polymeric mixture of claim 9, wherein the thermoplastic graft copolymer forms as micelles between the thermoplastic polymers of formula I and the thermoplastic polymer of formula II.

11. The thermoplastic polymeric mixture of claim 10, wherein the micelles range in diameter from 5 nm to 2000 nm.

12. The thermoplastic polymeric mixture of claim 9, wherein the ratio of thermoplastic polymers of formula I and the thermoplastic polymer of formula II ranges from 1 wt % to 99 wt %.

13. The thermoplastic polymeric mixture of claim 9, wherein the thermoplastic polymeric mixture has a tensile toughness ranging from 2 to 200 times the toughness of the thermoplastic polymer of formula I without the branched chain thermoplastic polymer of formula II.

14. An elastomeric composition comprising the thermoplastic polymeric mixture of claim 9.

15. An elastomeric composition comprising the thermoplastic polymeric mixture of claim 9, wherein the thermoplastic polymeric mixture is vulcanized, cross-linked, compatibilized, and/or compounded with one or more other elastomer, additive, modifier and/or filler.

16. A toughened engineering thermoplastic composition comprising the thermoplastic polymeric mixture of claim 9.

17. An asphalt composition comprising the thermoplastic polymeric mixture of claim 9, wherein the asphalt composition is in the form of an asphalt additive, modifier, and filler.

18. The asphalt composition of claim 17 further comprising:
a bitumen component.

19. The asphalt composition of claim 18, wherein the multiple stress creep recovery ranges from 1% to 100%.

20. An adhesive composition comprising:
the thermoplastic polymeric mixture of claim 9 and
a tackifier and/or a plasticizer blended with the thermoplastic polymeric mixture.

21. In a vehicle tire, the improvement comprising the thermoplastic polymeric mixture of claim 9.

22. The vehicle tire of claim 21, wherein the tire is vulcanized, cross-linked, compatibilized, and/or compounded with one or more other material.

23. A method of forming a thermoplastic graft copolymer, said method comprising:
mixing one or more thermoplastic polymers of formula I: 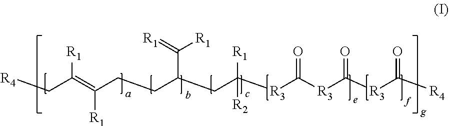
with a branched chain thermoplastic polymer of formula II: 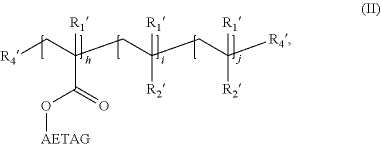
where
R¹ and R¹′ are independently selected at each occurrence thereof from the group consisting of H and methyl;
R² and R²′ are independently selected at each occurrence thereof from the group consisting of H, OH, halogen, —COOR⁵, —C(O)NR⁵R⁶, C₁-C₂₃ alkyl, and benzyl, where the C₁-C₂₃ alkyl can be optionally substituted with an aryl, heteroaryl, or heterocyclyl;
R³ is independently selected at each occurrence thereof from the group consisting of —X—R⁷—X—, C₁-C₂₃ alkylene, arylene, and heteroarylene;
R⁴ and R⁴′ are independently selected at each occurrence thereof from the group consisting of C₁-C₂₃ alkyl and benzyl, where the C₁-C₂₃ alkyl can be optionally substituted with an aryl, heteroaryl, heterocyclyl, carboxylic acid, oxirane, ester, thioester, or carbonotrithioate;
R⁵ and R⁶ are independently selected at each occurrence thereof from the group consisting of H and C₁₋₁₀ alkyl, hydoxyalkyl, or alkyloxirane;
R⁷ is independently selected at each occurrence thereof from the group consisting of 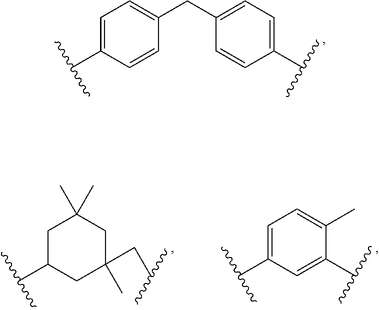
C₁₋₂₃ alkyl, where the C₁-C₂₃ alkyl can be optionally substituted with an aryl, heteroaryl, or heterocyclyl;
X is independently selected at each occurrence thereof from the group consisting of methylene, —NH—, or —O—.
AETAG is a (meth)acrylated epoxidized triacyl glyceride;
a, b, c, d, e, and f represent number average degrees of polymerization for repeat units of formula I that are distributed throughout the polymer chain in a statistically defined manner;
a, b, c, d, e, and f range from 0 to 100,000, where a+b+c+d+e+f ranges from 100 to 200,000;
g ranges from 1 to 5;
h, i, and j represent number average degrees of polymerization for repeat units of formula II that are distributed throughout the polymer chain in a statistically defined manner;
h ranges from 100 to 100,000; and
i and j range from 0 to 100,000, where the thermoplastic polymer of formula I is grafted to the thermoplastic polymer of formula II;
heating the blend; and
extruding the heated blend to form a thermoplastic graft copolymer.

24. The method of claim 23, wherein said heating is carried out at a temperature ranging from 100° C. to 300° C.

25. The method of claim 23, wherein the thermoplastic polymer of formula (I) is a copolymer or terpolymer.

26. The method of claim 25, wherein the copolymer is a styrene-butadiene-styrene, styrene-isoprene, ethylene-vinyl acetate polymer, and combinations thereof.

27. The method of claim 23, wherein the thermoplastic polymer of formula (I) is selected from the group consisting of polybutadienes, polyisoprenes, polystyrenes, polyacrylates, polylactides, vinyl polymers, polyesters, and combination thereof.

28. The method of claim 27, wherein the thermoplastic polymer of formula (I) is selected from the group consisting of polybutadienes, polyisoprenes, polystyrenes, polyacrylates, vinyl polymers, polyamides, and combinations thereof.

29. The method of claim 27, wherein the triacyl glyceride of the (meth)acrylated epoxidized triacyl glyceride of the branched chain thermoplastic polymer of formula II is selected from the group consisting of the triacyl glycerides of soybean oil, peanut oil, walnut oil, palm oil, palm kernel oil, sesame oil, sunflower oil, safflower oil, rapeseed oil, linseed oil, flax seed oil, colza oil, coconut oil, corn oil, cottonseed oil, olive oil, castor oil, false flax oil, hemp oil, mustard oil, radish oil, ramtil oil, rice bran oil, salicornia oil, tigernut oil, tung oil, and combinations thereof.

30. The method of claim 23, wherein the thermoplastic polymer of formula II has a number average molecular weight ranging from 10 kDa to 10000 kDa.

31. The method of claim 23, wherein the thermoplastic polymer of formula II subjected to said mixing is dissolved in a solvent.

32. The method of claim 31, wherein the solvent is selected from the group consisting of sub-epoxidized soybean oil, soybean oil, epoxidized soybean oil, methyl soyate, epoxidized methyl soyate, epoxidized soyate benzyl soyate, isoamyl soyate, vegetable oils, fatty acid methyl esters, epoxidized fatty acid methyl esters, citrate esters, and mixtures thereof.

33. The method of claim 32, wherein thermoplastic polymer of formula II in the solvent is in a concentration ranging from 1 wt % to 99 wt %.

34. The method of claim 23, wherein the weight percent ratio of the thermoplastic polymers of formula I and the thermoplastic polymers of formula II ranges from 1 wt % to 99 wt %.
